(19) United States
(12) Patent Application Publication
(10) Pub. No.: US 2015/0074554 A1
(43) Pub. Date: Mar. 12, 2015

(54) CONTENT PRESENTATION METHOD AND PROGRAM

(71) Applicant: Panasonic Intellectual Property Corporation of America, Torrance, CA (US)

(72) Inventors: Taiji Sasaki, Osaka (JP); Minehisa Nagata, Osaka (JP); Kouji Miura, Osaka (JP); Shunji Harada, Osaka (JP)

(21) Appl. No.: 14/385,780

(22) PCT Filed: Jan. 15, 2014
(86) PCT No.: PCT/JP2014/000135

§ 371 Date: Sep. 17, 2014

(30) Foreign Application Priority Data
Jan. 18, 2013 (JP) 2013-007749

(51) Int. Cl. H04L 29/08; H04L 12/18; G06F 3/0481

(52) U.S. Cl. CPC H04L 67/22; G06F 3/0481; H04L 12/1813
USPC 715/753

(57) ABSTRACT

A content presentation method includes: obtaining behavior history information of a user; determining a frequency for generating content based on the behavior history information and generating the content at the determined frequency, the content being for interaction with the user made by a device; and presenting the generated content to the user by distributing the generated content. For example, the determining further includes determining a type of the content to be generated based on the behavior history information and generating the content of the determined type.

### TECHNICAL FIELD

The present invention relates to a content presentation method and a program.

### BACKGROUND ART

Patent Literature (PTL) 1 discloses a network management system to which the principle of Social Networking Service (hereinafter also referred to as SNS) is applied to a device. With the technique disclosed in PTL 1, a relationship like a friendship on Facebook is established between a user and an object or between objects, which allows SNS-like communication between the user and the device.

PTL 2 discloses a system which generates a tweet to be posted, based on information on the running condition of a vehicle, and automatically posts the generated tweet on behalf of the user.

### CITATION LIST

### Patent Literature

[PTL 1] US Patent Application Publication No. 2011/0161478

[PTL 2] Japanese Unexamined Patent Application Publication No. 2012-008969

### SUMMARY OF INVENTION

### Technical Problem

When a device generates and posts a content item such as a tweet described above, the number of content items to be posted by the device may be significantly greater than the number of content items posted by human being. Greater number of posted content items increases the processing load on a distribution server which distributes these content items.

In the present invention, a content presentation method and so on are provided which are capable of reducing the processing load on the distribution server without affecting the usability.

### Solution to Problem

A content presentation method according to an aspect of the present invention includes: obtaining behavior history information of a user; determining a frequency for generating content based on the behavior history information and generating the content at the determined frequency, the content being for interaction with the user made by a device; and presenting the generated content to the user by distributing the generated content.

It is to be noted that general or specific aspects of the above may be provided by a system, a method, an integrated circuit, a computer program, or a computer-readable recording medium such as a CD-ROM, and an arbitrary combination of a system, a method, an integrated circuit, a computer program, and a recording medium.

### Advantageous Effects of Invention

The content presentation method according to the present invention is capable of reducing the processing load on the distribution server without affecting the usability.

### BRIEF DESCRIPTION OF DRAWINGS

FIG. 1 is a diagram indicating a whole image of a service provided in the embodiment.

FIG. 2 is a diagram indicating a service type (own data center type) in the embodiment.

FIG. 3 is a diagram indicating a service type (IaaS-based type) in the embodiment.

FIG. 4 is a diagram indicating a service type (PaaS-based type) in the embodiment.

FIG. 5 is a diagram indicating a service type (SaaS-based type) in the embodiment.

FIG. 6 is a block diagram indicating a configuration of a content generation-and-view system according to the embodiment.

FIG. 7 illustrates data structure in a device management DB according to the embodiment.

FIG. 8 illustrates data structure in an operation history DB according to the embodiment.

FIG. 9 illustrates operation parameter definition according to the embodiment.

FIG. 10 illustrates data structure in a user-and-device management DB according to the embodiment.

FIG. 11 illustrates data structure in a tweet DB according to the embodiment.

FIG. 12 illustrates data structure in a view history DB according to the embodiment.

FIG. 13 illustrates a tweet generation scheme according to the embodiment.

FIG. 14 illustrates a parameter on a tweet generation frequency according to the embodiment.

FIG. 15 illustrates a tweet generation scheme in which the tweet generation frequency is changed using a parameter on the tweet generation frequency according to the embodiment.

FIG. 16 illustrates display of tweet view result according to the embodiment.

FIG. 17 illustrates another example of the user-and-device management DB according to the embodiment.

FIG. 18 illustrates Modification 1 of the data structure in the tweet DB according to the embodiment.

FIG. 19 is a block diagram indicating a modification of a content generation-and-view system according to the embodiment.

FIG. 20 illustrates a request ID and request parameter definition.

FIG. 21A illustrates First example of display of an operation recommendation tweet.

FIG. 21B illustrates Second example of display of an operation recommendation tweet.

FIG. 21C illustrates Third example of display of an operation recommendation tweet.

FIG. 21D illustrates Fourth example of display of an operation recommendation tweet.

FIG. 22 illustrates a modification of the user-and-device management DB for providing a human-like character to the device.

FIG. 23 illustrates a modification of display of the tweet view result.

FIG. 24 illustrates Modification 3 of the data structure in the tweet DB according to the embodiment.

FIG. 25 illustrates First example of display of an operation request tweet.

FIG. 26 illustrates Second example of display of an operation request tweet.

FIG. 27 illustrates a modification of display of an operation recommendation tweet.

FIG. 28 illustrates adjustment of the content of the tweet by the devices.

FIG. 29 is a block diagram indicating another example of the configuration of the content presentation apparatus according to the embodiment.

FIG. 30 is a flowchart indicating another example of the content processing method of the content presentation apparatus according to the embodiment.

### DESCRIPTION OF EMBODIMENTS

### Underlying Knowledge Forming Basis of the Present Invention

The inventors have found that the following problems are caused in the communication scheme described in “Background” section.

The increasing number of Audio Visual (AV) home appliances, such as TVs and recorders, which are connectable to the Internet in recent years has lead to provision of services for distributing moving images such as movies and sports. Furthermore, more and more home appliances have been made connectable to the Internet. Such home appliances are called living home appliances, and include a weight scale, an active mass measure, a rice cooker, a microwave, a refrigerator, and so on. Thus, operation information including operation history or work information including work history, of the home appliance, is transmitted to a server via the Internet and accumulated and analyzed at the server. Furthermore, a variety of services are provided to users, using the analysis result from the server.

On the other hand, social networking services such as Facebook, Twitter, LINE, and so on are widely used as Internet services that prompt communication between users.

Facebook is a service which allows users to communicate with each other by establishing a friendship on the Internet, and by sharing, viewing, and replying to photos or texts describing each user's update posted by the user.

Twitter, or microblog, is a communication service which allows users to post short text sentences describing the user's update to a server and share the text sentences accumulated in the server among the users, which provides the users with fun.

LINE is a communication service which allows users to interchange short messages in real time.

Hereinafter, a text message or a photo describing each user's update posted by the user in such communication services is defined as a “tweet”.

In recent years, a service has been considered in which not users who are human beings but devices automatically generate tweets based on their current situations, and the users who are human beings view these tweets. For example, PTL 1 discloses a network management system to which the principle of social networking is applied. With the technique disclosed in PTL 1, a relationship like a friendship on Facebook is established between a user and an object or between objects, which allows SNS-like communication between the user and the device.

PTL 2 discloses a system which generates a tweet to be posted, based on information on the running condition of a vehicle, and automatically posts the generated tweet on behalf of the user.

When such a device automatically generates tweets, it is required to establish a database which allows recording and quickly searching a large amount of tweets. In general, the number of home appliances owned by humans is greater than the number of humans. Thus, when these devices are connected to the Internet and generate tweets as frequently as humans do, there is no doubt that the number of tweets generated by the devices exceeds the number of tweets generated by humans, which requires establishment of a large-scale database system.

Specifically, when the devices generate and post tweets as described above, the number of posted tweets may be significantly greater than the number of tweets posted by humans. The processing load on the server to which these tweets are posted increases as the number of tweets increases.

In the present invention, a content presentation method and so on are provided which are capable of reducing the processing load on the server without affecting the usability.

In order to solve the above-described issue, the content presentation method according to an aspect of the present invention includes: obtaining behavior history information of a user; determining a frequency for generating content based on the behavior history information and generating the content at the determined frequency, the content being for interaction with the user made by a device; and presenting the generated content to the user by distributing the generated content.

This allows determining the generation frequency of the device-related content based on the behavior history information of the user. Specifically, the generation frequency of the content is determined according to the probability that the user views the content. The probability is determined from the behavior history of the user. Thus, with the content presentation method according to the present invention, the processing load on the server can be reduced without affecting the usability.

In the conventional technique, although the type and the generation frequency of the content are determined based on whether the device has worked (or not worked), it has no relation to the behavior history information of the user who views the content. In the content presentation method according to the present invention, the type and the frequency of the content to be generated are determined taking into account the behavior history information of the user, thereby reducing the processing load on the server without affecting the usability.

For example, the determining may further include determining a type of the content to be generated based on the behavior history information and generating the content of the determined type.

This allows determining the type of the device-related content based on the behavior history information of the user. Specifically, the type of the content is determined according to the probability that the user views the content. The probability is determined from the behavior history of the user. Thus, with the content presentation method according to the present invention, the processing load on the server can be reduced without affecting the usability.

For example, in the presenting, a view request for the content from the user may be accepted and the content may be presented to the user according to the view request accepted, in the obtaining, information including a frequency of the view request accepted in the presenting may be obtained as the behavior history information, and in the determining, the content may be generated at a lower frequency as the frequency of the view request in the behavior history information is lower, or the content may be generated at a higher frequency as the frequency of the view request in the behavior history information is higher.

This allows presenting less content items to a user whose frequency of content view request is low. Thus, the content items which the user should view at once is reduced according to the view frequency of the user, thereby maintaining the number of content items which the user should view at once approximately constant irrespective of the view frequency. Thus, the processing load on the server can be reduced without affecting the usability.

For example, in the obtaining, information for identifying a first time period may be obtained as the behavior history information, the first time period being a time period in which the frequency of the view request accepted in the presenting is smaller than a first threshold, and in the determining, the content in the first time period identified from the behavior history information may be generated at a frequency lower than a frequency for generating the content in a time period other than the first time period.

This allows presenting less content items in a time period (first time period) in which the frequency of content view request by the user is low. Thus, the generation frequency of content items is reduced in the time period in which the probability that the user views the content item is low, and the generation frequency of content items is maintained in the time period in which the probability that the user views the content item is high. Thus, the processing load on the server can be reduced without affecting the usability.

For example, the type of the content may include a first type indicating content including an inquiry to the user and a second type different from the first type, and in the determining, the content of the second type may be generated at a lower frequency as the frequency of the view request in the behavior history information is lower, or the content of the second type may be generated at a higher frequency as the frequency of the view request in the behavior history information is higher.

This allows reducing the generation frequency of content items including an inquiry to the user whose frequency of content view request is low. This is because, even when a content item including an inquiry is presented to the user whose frequency of content view request is low, it is inferred that relatively long time elapses before the user views the content item and it is likely that an appropriate device control cannot be performed even when an answer to the inquiry is obtained at that timing. When it is assumed that the appropriate control cannot be performed as a result of content-item viewing by the user, generation frequency of content items is reduced.

For example, the type of the content may include a first type indicating content including an inquiry to the user and a second type different from the first type, and in the determining, the content of the second type may be generated at a lower frequency as the frequency of the view request in the behavior history information is lower, or the content of the second type may be generated at a higher frequency as the frequency of the view request in the behavior history information is higher.

This allows presenting less content items to the user whose operation frequency of the device is lower. Thus, the number of content items which the user should view at once is reduced according to the frequency of operation by the user. Thus, the processing load on the server can be reduced without affecting the usability.

For example, in the obtaining, information for identifying a second time period, in which the frequency of the operation of the device by the user is lower than a second threshold, may be obtained as the behavior history information, the information being defined based on the history of the operation by the user, and in the determining, the content may be generated in the second time period identified from the behavior history information at a frequency lower than a frequency for generating the content in a time period other than the second time period.

This allows reducing generation frequency of content items in the time period (second time period) in which the user has operated the device and maintaining generation frequency of content items in the third time period. Since it can be inferred that the user is likely to control the device in the third time period in the future too, generation and presentation of the content items in the third time period allows reducing the content items without affecting the convenience of the user.

For example, the type of the content may include a first type indicating content including an inquiry to the user and a second type different from the first type, and in the determining, the content of the first type may be generated at a lower frequency as the frequency of the operation in the behavior history information is lower, or the content of the first type may be generated at a higher frequency as the frequency of the operation in the behavior history information is higher.

This allows reducing the generation frequency of content items including an inquiry to the user whose frequency of operation of the device is lower. With this, the number of content items can be reduced without affecting the convenience of the user.

For example, the type of the content may include a first type indicating content including an inquiry to the user and a second type different from the first type, and in the determining, the content of the second type may be generated at a lower frequency as the frequency of the view request in the behavior history information is lower, or the content of the second type may be generated at a higher frequency as the frequency of the view request in the behavior history information is higher.

This allows reducing the generation frequency of content items when the user is not in a preset region and maintaining the generation frequency of content items when the user is in the region. Thus, it is possible to reduce the processing load on the server without affecting the usability.

For example, the program according to an aspect of the present invention may be a program for causing a computer to execute the above-described content presentation method.

This produces the same advantageous effect as that in the content presentation method above.

It is to be noted that general or specific aspects of the above may be provided by a system, a method, an integrated circuit, a computer program, or a computer-readable recording medium such as a CD-ROM, and an arbitrary combination of a system, a method, an integrated circuit, a computer program, and a recording medium.

Hereinafter, the embodiment shall be described in detail with reference to the Drawings.

It is to be noted that the embodiment described below is a comprehensive or specific example of the present invention. The numerical values, shapes, constituent elements, the arrangement and connection of the constituent elements, steps, the processing order of the steps etc. shown in the following embodiment are mere examples, and thus do not limit the present invention. Furthermore, out of the constituent elements in the following embodiment, the constituent elements not stated in the independent claims describing the broadest concept of the present invention are described as optional constituent elements.

### (Whole Image of Service Provided)

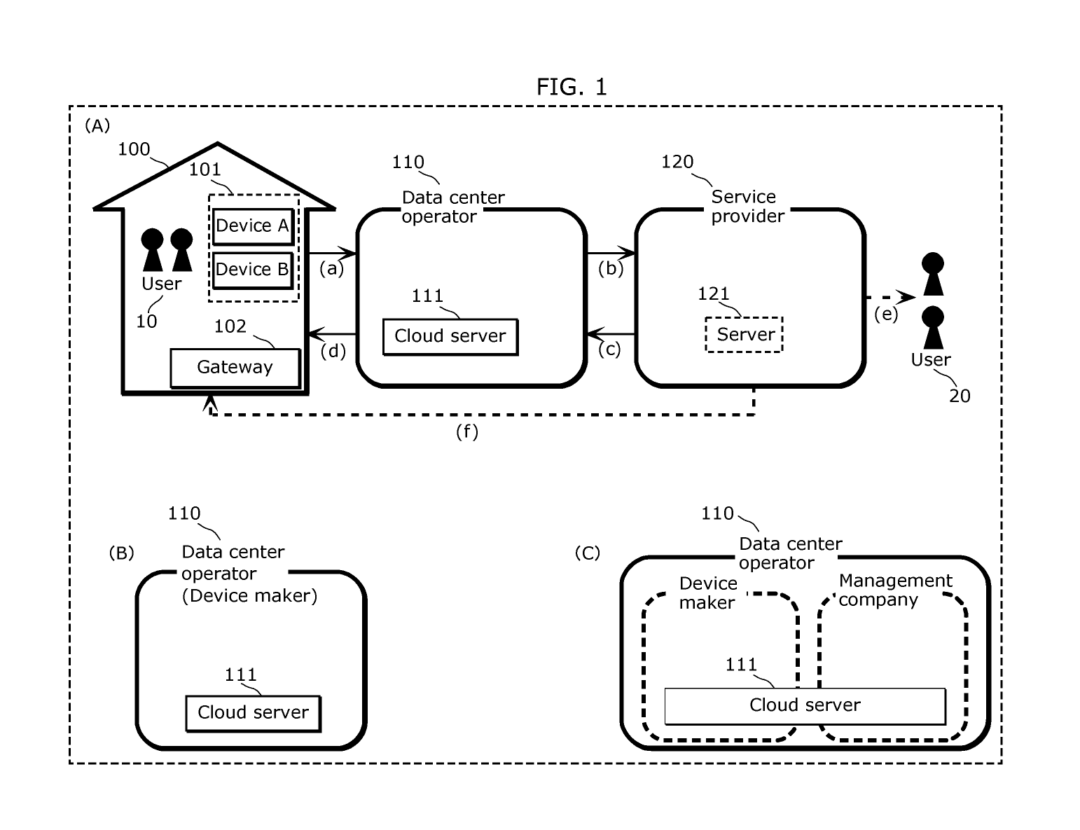

(A) in FIG. 1 indicates a whole image of a service according to the embodiment below.

A group 100 is a company, community, home, and so on, of any size. The group 100 includes plural devices 101, namely a device A and a device B, and a home gateway 102. The plural devices 101 may include a device connectable to the Internet (such as a smartphone, a PC, and a TV) and a device not connectable to the Internet by itself (such as a light, a washing machine, and a refrigerator). A device which is not connectable to the Internet by itself but is connectable to the Internet via the home gateway 102 may be included. Furthermore, the group 100 includes a user 10 who uses the plural devices 101.

The data center operator 110 has a cloud server 111. The cloud server 111 is a virtual server which links with a variety of devices via the Internet. The data center operator 110 manages a huge amount of data (big data) which are difficult to deal with by a general database management tool. The data center operator 110 manages data and the cloud server 111, and operates the data center for the management. The services provided by the data center operator 110 shall be described in detail later. Here, the data center operator 110 is not limited to a company which only manages the data and operates the cloud server 111. For example, when a device maker which develops and manufactures one of the devices 101 also manages data and the cloud server 111, the device maker corresponds to the data center operator 110 ((B) in FIG. 1). Furthermore, the data center operator 110 is not limited to one company. For example, when the device maker manages data and operates the cloud server 111 in collaboration or by sharing with an other management company, both or one of them corresponds to the data center operator 110 ((C) in FIG. 1).

The service provider 120 has a server 121. The server 121 here can be of any size and includes a memory in a PC for individual use, for example. There are cases where the service provider does not have a server 121.

It is to be noted that the home gateway 102 is not mandatory in the above service. For example, when the cloud server 111 manages all the data, the home gateway 102 is not needed. Furthermore, there are cases where the devices not connectable to the Internet by themselves do not exist, such as when all the devices at home are connected to the Internet.

Next, description shall be provided on the flow of log information (operation history information and work history information) for the device in the above service.

First, the device A or the device B in the group 100 transmits each of the log information to the cloud server 111 in the data center 110. The cloud server 111 accumulates the log information of the device A or the device B ((a) in FIG. 1). Here, the log information indicates the status of operation and time-and-date of work of the devices 101, for example. Examples of the log information include a viewing history of a TV, video recording timer information of a recorder, the time-and-date of operation of a washing machine, the amount of laundry, the time-and-date or the number of openings and closings of a refrigerator, and so on. However, the log information is not limited to the above and includes all information obtainable from any devices. There are cases where the log information is provided to the cloud server 111 directly from the devices 101 themselves via the Internet. Furthermore, the log information may be temporarily accumulated to the home gateway 102 from the devices 101 and then provided to the cloud server 111 from the home gateway 102.

Next, the cloud server 111 in the data center operator 110 provides the accumulated log information to the service provider 120 by a constant unit. Here, the unit may be in a size by which the information accumulated by the data center operator can be organized and provided to the service provider 120, or in a size which is requested by the service provider 120. Although it has been described as the constant unit, this is not mandatory and the amount of information to be provided changes according to the situation in some cases. The log information is stored in the server 121 of the service provider 120, as necessary ((b) in FIG. 1). The service provider 120 organizes the log information to be suitable for the service to be provided to the user, and provides the information to the user. The user to be provided with the information may be the user 10 who uses the devices 101 or an external user 20. The service may be provided to the user directly from the service provider ((b) and (e) in FIG. 1), for example. Furthermore, the service may be provided to the user via the cloud server 111 in the data center operator 110 again ((c) and (d) in FIG. 1), for example. Furthermore, the log information may be organized to be suitable for the service to be provided to the user by the cloud server 111 in the data center operator 110, and may be provided to the service provider 120.

It is to be noted that the user 10 and the user 20 may be different or the same.

### Embodiment

In the embodiment, description shall be provided on a content presentation apparatus, a content presentation method, and a system which are capable of reducing the processing load on a distribution server without affecting the usability. Although the description is based on a “tweet” which is a text sentence or a photo describing the state of the user and is posted by the user, the present invention is not limited to this.

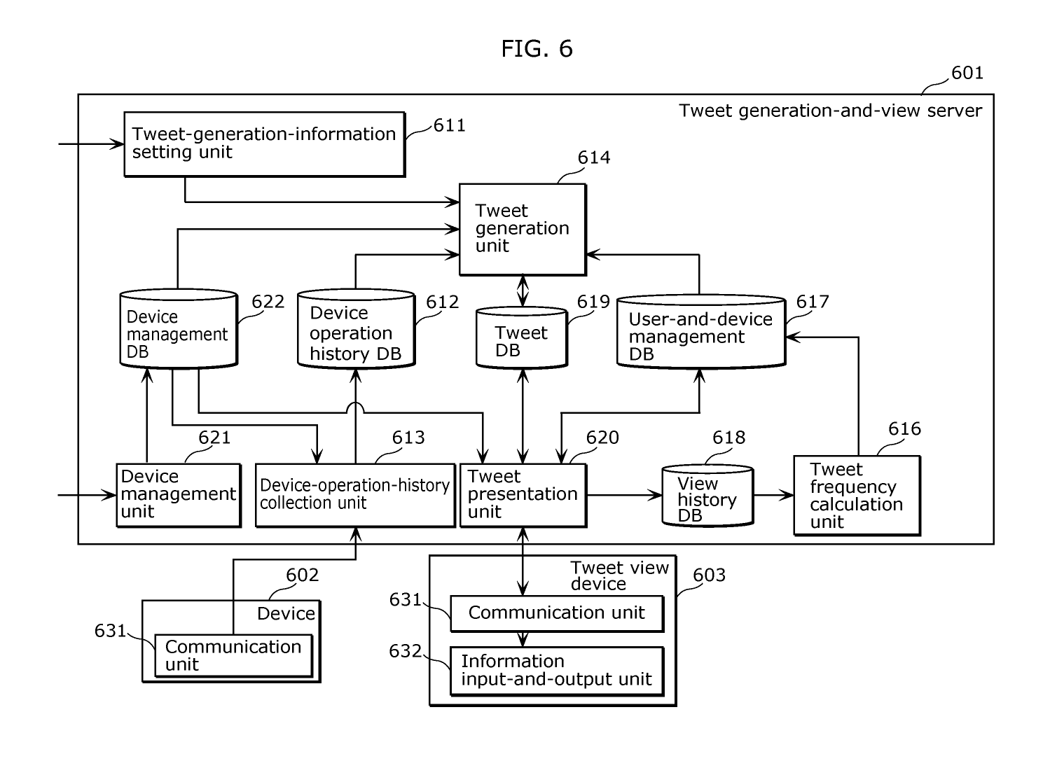

FIG. 6 is a block diagram indicating a configuration of a tweet generation-and-presentation system according to the embodiment. It is to be noted that the tweet generation-and-presentation system is an example of the content presentation system.

As shown in FIG. 6, the tweet generation-and-presentation system includes a tweet generation-and-view server 601, a device 602, and a tweet view device 603. A part or all of a block of the tweet generation-and-view server 601 belongs to one of (i) the cloud server in the data center operator and (ii) the server in the service provider.

The device 602 is one of plural devices 101 that belong to the group 100.

The device 602 includes a communication unit 631.

The communication unit 631 transmits an operation of the device 602 to the tweet generation-and-view server 601 as device operation history information. Examples of the device operation history include: a code number of a button pressed by the user out of buttons of a microwave; a function identifier corresponding to the function selected by the user; and heating time of the microwave. The device 602 is assigned with a unique device ID managed by a device management DB 622, and the communication unit 631 transmits the device operation history together with the device ID. Although only one device 602 is illustrated in FIG. 6, the tweet generation-and-view server 601 can support plural devices 602 when the devices are connected to the tweet generation-and-view server 601. The device operation history information is an example of the behavior history information.

The tweet view device 603 includes a communication unit 631 and an information input-and-output unit 632.

The communication unit 631 is connected to the network and transmits communication data. The tweet view device 603 obtains a tweet from the tweet generation-and-view server 601 via the communication unit 631.

The information input-and-output unit 632 accepts input of information and outputs information. The information input-and-output unit 632 outputs the tweet obtained by the communication unit 631. Specific examples of the information input-and-output unit 632 include a display for outputting information; and a keyboard or a touch panel which accepts input of information. Specific examples of the tweet view device 603 include a device such as a PC or a smartphone.

The tweet generation-and-view server 601 includes a tweet-generation-information setting unit 611, a device operation history DB 612, a device-operation-history collection unit 613, a tweet generation unit 614, a tweet frequency management DB 615, a tweet frequency calculation unit 616, a user-and-device management DB 617, a view history DB 618, a tweet DB 619, a tweet presentation unit 620, a device management unit 621, and a device management DB 622. It is to be noted that the tweet DB 619 does not have to be included in the tweet generation-and-view server 601 and may be included in an external apparatus connected via the network. In this case, when communicating with the tweet DB 619, communication is performed through an appropriate communication interface.

The device management unit 621 sets profile information, such as the device ID, of the device 602 connected to the tweet generation-and-view server 601. The device management unit 621 records the set information to the device management DB 622.

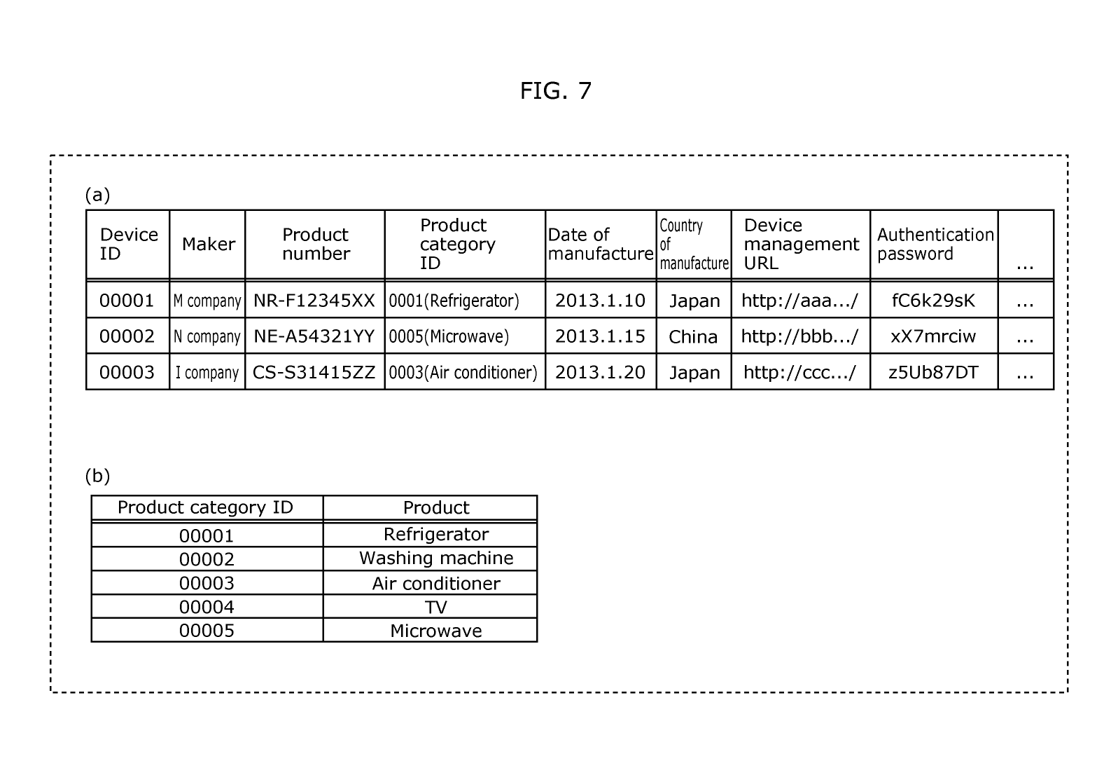

FIG. 7 illustrates data structure in the device management DB according to the embodiment.

In FIG. 7, (a) indicates an example of the profile information of a device which is recorded in the device management DB 622.

The “device ID” is an ID for discerning the device as described above, and is set to be unique in the device management DB.

The “maker” indicates the name of maker which manufactures the device.

The “product number” indicates the number for distinguishing the device and is set by the maker.

The “product category ID” indicates an ID for defining the content of the product. Specifically, the product category ID is table information as indicated in (b) in FIG. 7. For example, the product category IDs 00001, 00002, 00003, 00004, and 00005 are assigned to the refrigerator, the washing machine, the air conditioner, the TV, and the microwave, respectively. By referring to the product category ID, it can be understood that the product having the device ID of 00001 in (a) in FIG. 7 is a refrigerator since the product category ID is 0001. Likewise, it can be understood that a product having the device ID of 00002 is a microwave since the product category ID is 0005, and the product having the device ID of 00003 is an air conditioner since the product category ID is 0003.

The “date of manufacture” indicates the date on which the device is manufactured. The “country of manufacture” indicates the country in which the device is manufactured.

The “device management URL” indicates a URL that stores more detailed information including other profile information of the device. Accessing to the URL allows obtaining the more detailed information as described above.

The “authentication password” is a password for obtaining an access right for viewing the tweet of the device.

In addition to the attribute in the profile information indicated in (a) in FIG. 7, information related to other attribute, such as the dimension or mass, of the device may be stored.

The device management unit 621 may set the above profile information: at a timing when the maker of the device 602 manufactured the device 602; or by automatically inquiring to a server and the like in the maker at a timing when the device 602 is connected to the tweet generation-and-view server 601.

It is to be noted that the device ID managed by the device management DB 622 is transmitted to the device 602 and stored in a storage device such as a memory or an HDD of the device 602. When the device 602 is connected to the tweet generation-and-view server 601 as described above, the discerning on the device 602 by the tweet generation-and-view server 601 is performed through communication, simultaneously with the connection, of the device ID stored in the above manner.

Referring back to FIG. 6, the device-operation-history collection unit 613 obtains the device operation history information from the device 602 and accumulates the device operation history into the device operation history DB 612 in association with the device ID assigned to the device 602.

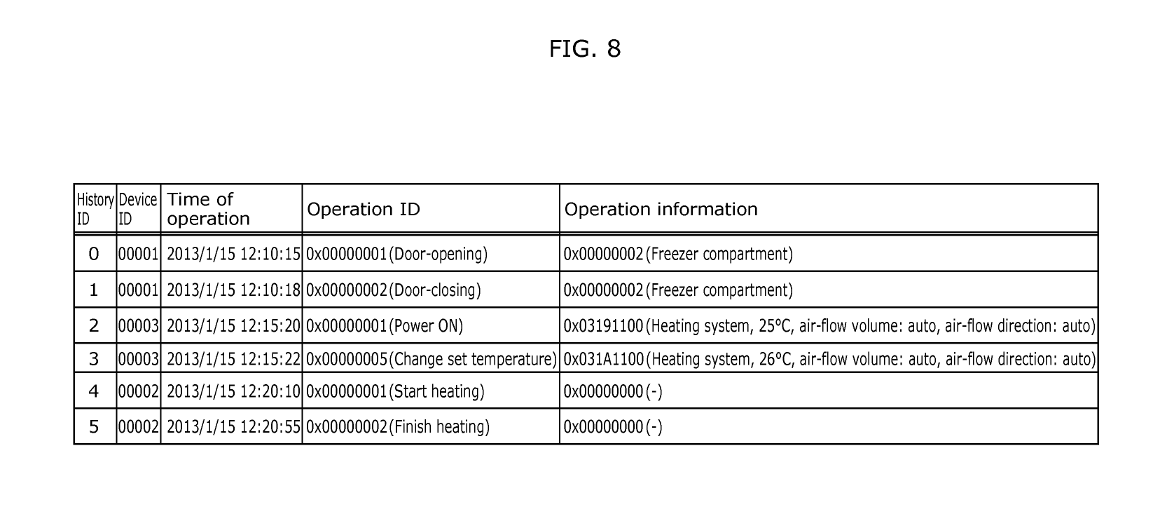

FIG. 8 illustrates the data structure in an operation history DB according to the embodiment.

FIG. 8 indicates an example of the device operation history information accumulated in the device operation history DB 612. The device operation history information is recorded taking the history ID, the device ID, the operation time, the operation ID, and the operation information, as one unit.

The “history ID” is the number for managing the device operation history, and is assigned to be unique in the database.

The “operation time” indicates the time at which the operation of the device is performed.

The “operation ID” indicates the content of operation performed on the device.

The “operation information” is data indicating the operation target and the state which are indicated by the operation ID.

The “operation ID” and the “operation information” are defined as specifications which are preliminarily defined per product category ID. This is called operation parameter definition. The device-operation-history collection unit 613 is capable of processing the content of the operation accumulated in the device operation history information, by referring to the device management DB 622, obtaining the product category ID corresponding to the device ID, and further referring to the operation parameter definition indicated below. Although description below is provided based on an assumption that the “operation ID” and the “operation information” are defined per product category ID, the product category ID may be defined per smaller unit such as the product number.

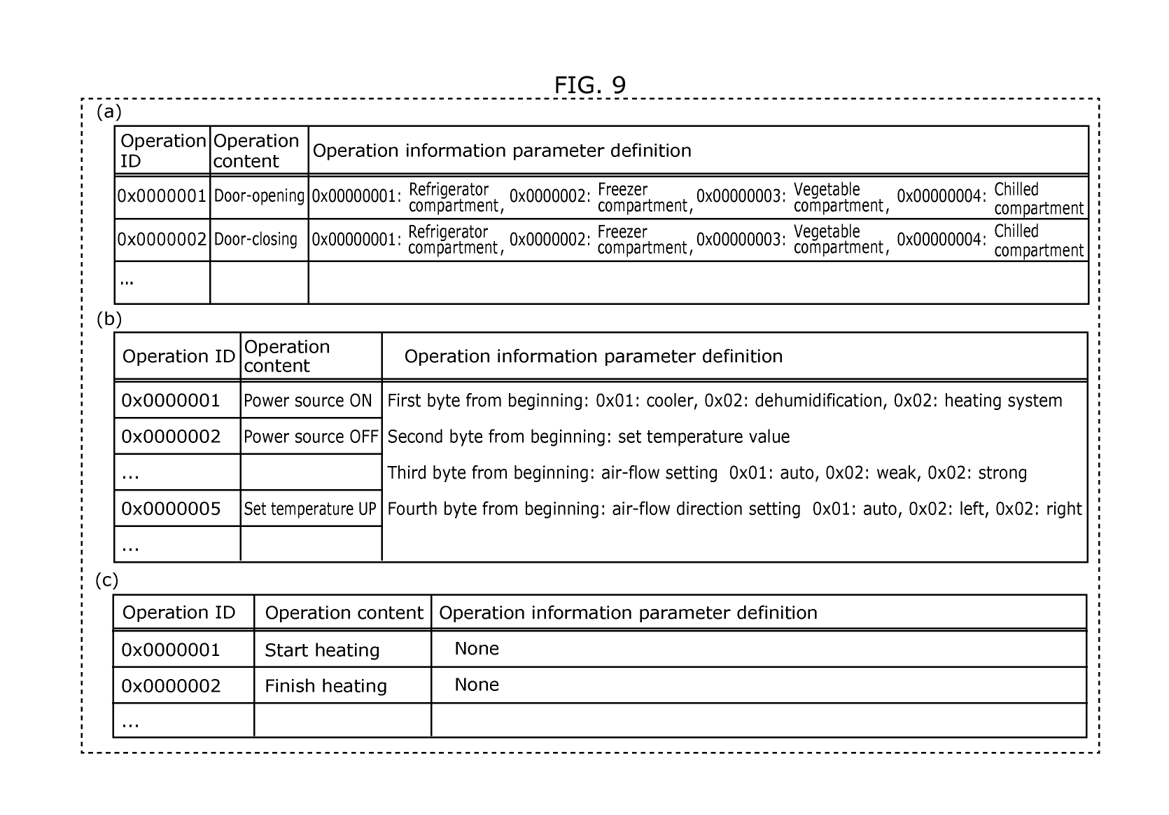

FIG. 9 illustrates operation parameter definition according to the embodiment.

Specific examples of the content of operation parameter definition are indicated in FIG. 9. In FIG. 9, (a) indicates operation parameter definition for the product category ID=0001 (refrigerator). In the operation ID definition, the operation ID=0x00000001 indicates door-opening and the operation ID=0x00000002 indicates door-closing. In the operation information definition, 0x00000001 indicates the refrigerator compartment, 0x00000002 indicates the freezer compartment, 0x00000003 indicates the vegetable compartment, and 0x00000004 indicates the chilled compartment.

In FIG. 9, (b) indicates operation parameter definition for the product category ID=0003 (air conditioner). In the operation ID definition, the operation ID=0x00000001 indicates the power source ON, the operation ID=0x00000002 indicates the power source OFF, and the operation ID=0x00000005 indicates the set temperature UP (increase). In the operation information definition, the set value of the air conditioner after the operation is indicated. The first byte from the beginning indicates the operation mode of the air conditioner. 0x01 indicates the cooling system, 0x02 indicates the dehumidification, and 0x03 indicates the heating system. The second byte from the beginning indicates the set temperature value. The third byte from the beginning indicates the setting for air-flow volume. 0x01 indicates auto, 0x02 indicates “weak”, and 0x03 indicates “strong”. The fourth byte from the beginning indicates the setting for air-flow direction. 0x01 indicates auto, 0x02 indicates “left”, and 0x03 indicates “right”.

In FIG. 9, (c) indicates the operation parameter definition for the product category ID=0005 (microwave). In the definition for operation ID, the operation ID=0x00000001 indicates “start heating”, and the operation ID=0x00000002 indicates “finish heating”. The definition for operation information is not set.

In the example of the operation history information in FIG. 8, the operation parameter definition in FIG. 9 is referred. Since the device ID corresponding to the history ID=0 in FIG. 8 is 00001 and the product category ID corresponding to the product ID=00001 in FIG. 7 is 0001 (refrigerator), the operation parameter definition for the refrigerator ((a) in FIG. 9) is applied. Since the history ID=0 is the operation ID=0x00000001, it can be understood that the operation content is door-opening by referring to the operation parameter definition in (a) in FIG. 9, and that the target is the freezer compartment based on the operation parameter definition in (a) in FIG. 9. In this manner, it can be understood that the operation whose history ID=0 is door opening of the freezer compartment performed on the refrigerator whose device ID=0001, at 12:10:15 of 2013 Jan. 15.

In another example, since the device ID corresponding to the history ID=2 is 00003 and the product category ID corresponding to the product ID=00003 in FIG. 7 is 0003 (air conditioner), the operation parameter definition for the air conditioner ((b) in FIG. 9) is applied. Since the history ID=2 is the operation ID=0x00000001, it can be understood that the operation content is turning the power source ON, by referring to the operation parameter definition in (b) in FIG. 9. Since the operation information=0x03191100, it is further understood that the air conditioner after the operation is set as follows: operation mode=heating system, set temperature=25° C., air-flow volume=auto, and air-flow direction=auto, by referring to the operation parameter definition in (b) in FIG. 9. In this manner, it can be understood that the operation whose history ID=2 is turning ON the power source of the air conditioner whose device ID=0003, at 12:15:20 of 2013 Jan. 15, and the setting of the air conditioner after the operation is as follows: the operation mode=heating system, the set temperature=25° C., the air-flow volume=auto, and the air-flow direction=auto.

Referring back to FIG. 6, the tweet presentation unit 620 is a microblog server or an SNS server for viewing tweets, and provides tweets by the user or the device to the tweet view device 603, using a communication protocol such as Hypertext Transfer Protocol (HTTP). The tweet presentation unit 620 manages the user and the device 602 accessing the tweet generation-and-view server 601 using the tweet view device 603, using the user-and-device management DB 617.

There is a case where a course of processing is described as follows: “A tweet is distributed from the tweet generation unit 614 to the tweet view device 603.” The course of processing includes: the tweet generation unit 614 which registers the generated tweet into the tweet DB 619; and the tweet presentation unit 620 which provides the registered tweet to the tweet view device 603. Furthermore, when the tweet DB 619 is installed to an external device as described in the above, it is also possible to cause the external device to distribute the tweet.

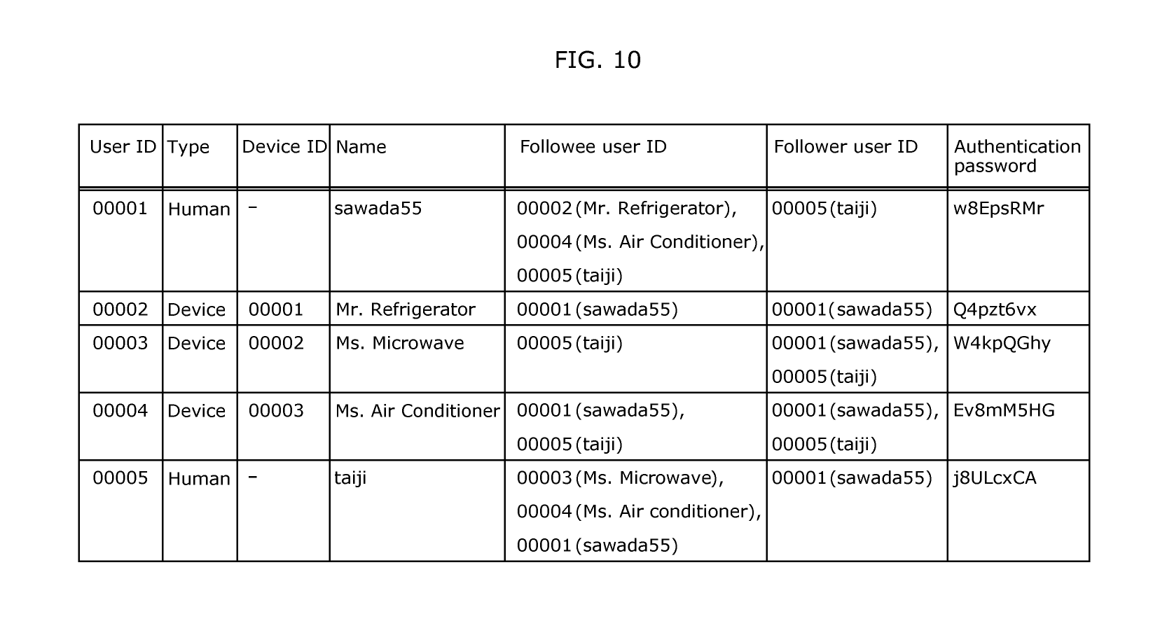

FIG. 10 illustrates data structure in a user-and-device management DB according to the embodiment.

FIG. 10 indicates an example of the profile information recorded on the user-and-device management DB 617. In the user-and-device management DB 617, the followings are recorded as a single entry: a user ID, a type, a name, a followee user's user ID (or a followee device's device ID), a follower user's user ID (or a follower device's device ID), and an authentication password.

The “user ID” is a unique ID of the user and is managed in the tweet presentation unit 620.

The “type” is flag information indicating whether the user is a person or a device.

The “name” indicates the name of the user.

The “device ID” is a device ID managed by the device management DB 622 when the “type” is the device.

The “followee user's user ID” is a group of IDs of users who are followed by the user.

The “follower user's user ID” is a group of IDs of users who follow the user. Here, to “follow” is to make a tweet from a designated user viewable in a timeline which is the first page. For example, when a user A is to follow a user B, a tweet generated by the user B is displayed on the timeline of tweets viewed by the user A.

The “authentication password” is used for account management when the user accesses the tweet presentation unit 620.

Description shall be provided on how to set the followee user or the followee device. The tweet presentation unit 620 provides the user with a page for searching the user-and-device management DB 617. The user searches the device ID or the name using the provided page. The tweet presentation unit 620 allows setting the users or the devices searched out by the user as targets to follow. When the user A designates the user B as a followee, a confirmation request may be issued to the user B, thereby allowing the user A to follow the user B only when the user B accepts the confirmation. When the user A designates the user B as a followee, it is an option to set that a confirmation is accepted using a password associated with the device. In this case, a password for the entry in the device management DB 622 may be used.

Although the terms “followee” or “follower” are used in the description to define the relationship between the users in the tweet presentation unit 620, the relationship between the users is not limited to this relationship. The relationship between the users may be “friend relationship” as defined in SNSs such as Facebook, for example. In this case, the embodiment can be applied when it can be assumed that the users or devices having a friend relationship are in the relationship of “followee” and “follower”. Furthermore, the relationship between the users may be “family relationship”, for example. In this case, the embodiment can be applied when it can be assumed that the users or devices having the family relationship are in the relationship of “followee” and “follower”. Furthermore, the relationship between the users may be “ownership relationship”, for example. In this case, the embodiment can be applied when it can be assumed that the users or devices having ownership relationship are in the relationship of “followee” and “follower”. It is an option to share tweets in a limited group or community by allowing only users having the “friend relationship”, “family relationship”, and “ownership relationship” to search or view the tweets by the users or the devices.

When a new user accesses the tweet presentation unit 620, the tweet presentation unit 620 presents “user sign up”, creates an account for each user according to the result of input of the profile information by the user, and adds the profile of the user to the user-and-device management DB 617. The user ID=00001 and 00005 in FIG. 10 correspond to the users who have been added according to the above procedure. Furthermore, the tweet presentation unit 620 registers the device into the user-and-device management DB 617 as a user, based on the profile of the device registered in the device management DB 622. For example, the user ID=0002, 0003, and 0004 in FIG. 10 correspond to the respective devices registered in the device management DB 622. Since the user whose user ID=0002 has the device ID=0001, it can be understood that the device is a refrigerator having the device ID=00001, by referring to (a) in FIG. 7.

When receiving a tweet view command from the user, the tweet presentation unit 620 searches and obtains the tweet by a folowee user of the user from among the tweets stored in the tweet DB 619, and transmits the obtained tweet to the tweet view device 603.

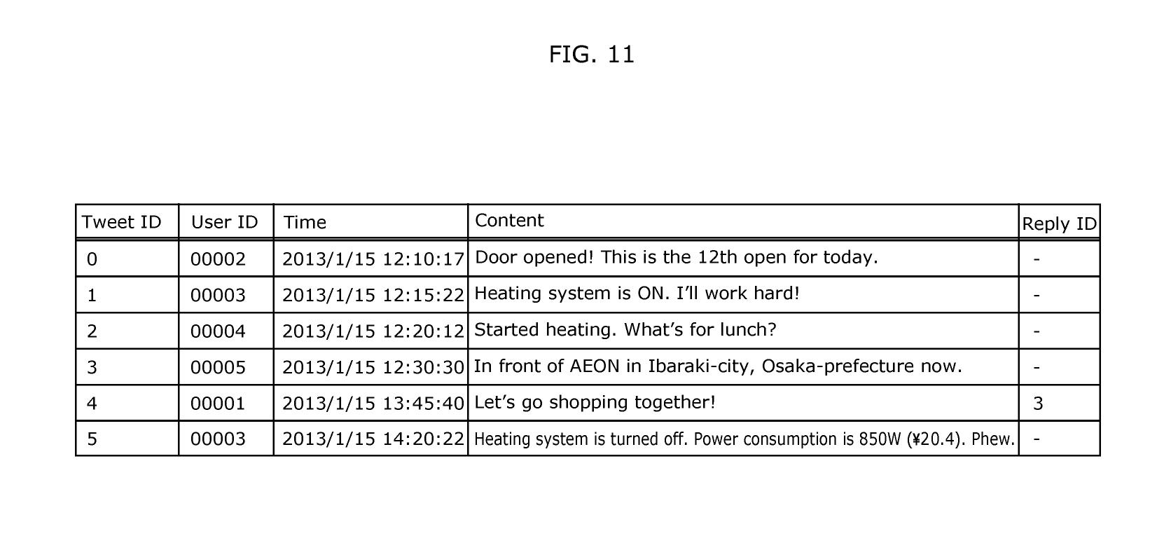

FIG. 11 illustrates data structure in the tweet DB according to the embodiment.

FIG. 11 indicates a data structure of a tweet accumulated in the tweet DB 619. The data stored in the tweet DB 619 is accumulated as a single entry including a tweet ID, a user ID, a time, content, and a reply ID.

The “tweet ID” is a unique management number in the tweet DB 619, and is a management number set to each tweet.

The “user ID” is a user ID in the user-and-device management DB 617 for identifying the user who has generated the tweet.

The “time” is a time at which the tweet is generated and is a time at which the tweet is added to the tweet DB 619, for example.

The “content” is the content itself such as the text or a photo in the tweet.

The “reply ID” indicates the tweet ID of the user to which a reply for the entry is sent. By referring to the reply ID, it becomes possible to determine to which tweet the entry replies. In the example in FIG. 11, since the reply ID of the tweet saying “Let's go shopping together!” whose tweet ID=4 is 3, it can be understood that the tweet whose the tweet ID=4 is a reply to the tweet saying “In front of AEON, Ibaraki-city, Osaka-Prefecture now.” whose tweet ID=3.

The tweet presentation unit 620 provides not only display of tweets to the user but also post of tweets or reply to the tweets by the user. The tweet presentation unit 620 presents a page for posting tweets to the tweet view device 603, and the user inputs a tweet message though the information input-and-output unit 632 of the tweet view device 603. When receiving the tweet message, the tweet presentation unit 620 adds the received tweet message to the tweet DB along with the user ID of the user.

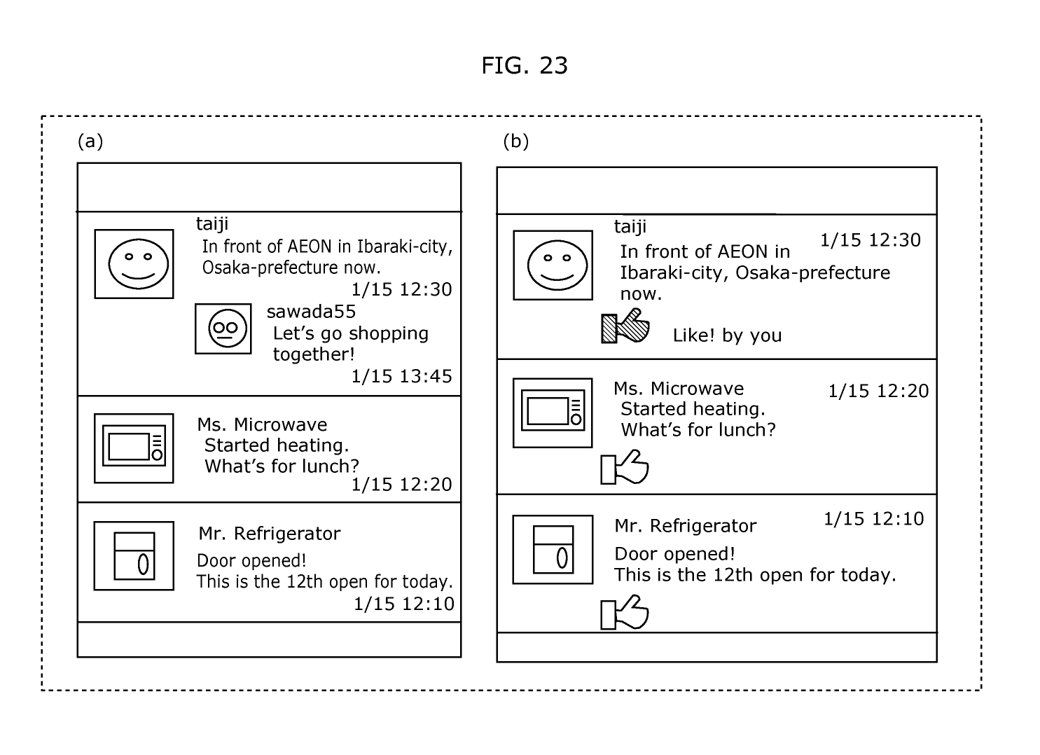

In the example in FIG. 10 and FIG. 11, when the user (sawada55) whose user ID=00001 executes a tweet view command to the tweet presentation unit 620, the tweet presentation unit 620 refers to the user-and-device management DB 617 in FIG. 10, and obtains the current tweets generated by the followee users whose user IDs are 00002, 00004, and 00005, of the user, and the user himself/herself (user ID=00001). In the example in FIG. 11, the tweet presentation unit 620 obtains the tweets whose tweet IDs=0, 2, 3, and 4, and transmits the obtained tweets to the tweet view device 603, and the tweet view device 603 displays the tweets. An example of Graphical User Interface (GUI) when sawada55 causes the tweet view device 603 to display the tweets in the example in FIG. 11 is indicated in (a) in FIG. 23. The tweet view command indicates a tweet obtainment command on Web Application Programming Interface (WebAPI), for example.

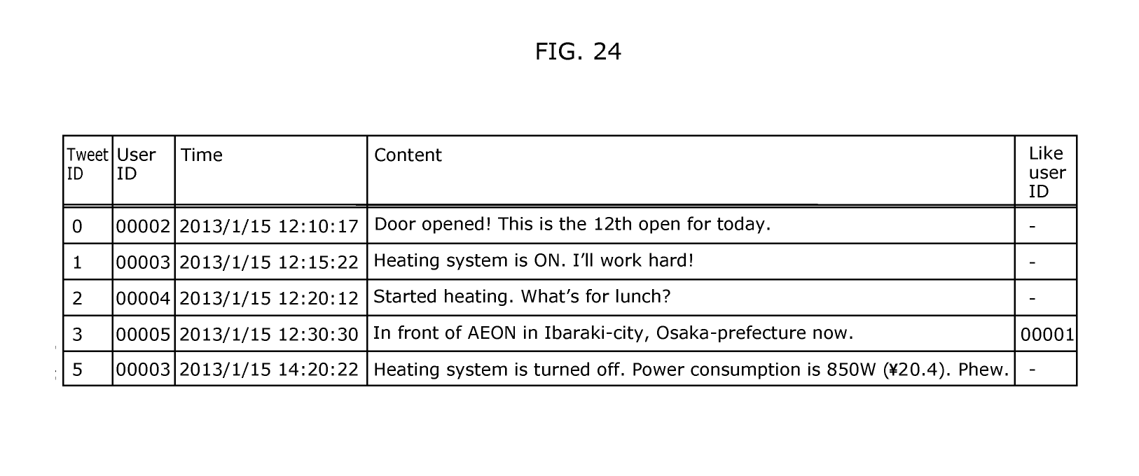

In addition, Facebook has a “Like” button as an interface (I/F) for easily expressing positive or favorable opinion to a tweet generated by a user. The “Like” button is displayed along with the tweet, and when the button is clicked, the pressing of “Like” by the user is presented to the user interface. An example of configuration of the tweet DB for providing the “Like” button is indicated in FIG. 24. In FIG. 24, a user ID of a user who has selected the “Like” button is registered in the entry. When a user selects the “Like” button added to a tweet, the tweet presentation unit 620 designates the user ID of the user to a “Like user ID” in the tweet entry in the tweet DB. This allows determining to which tweet each user has selected “Like”. In FIG. 23, (b) indicates an example of presentation of the “Like” button. Although Facebook adopts the “Like” button as the tool for easily expressing positive or favorable opinion to a tweet, the name of such a tool is different SNS by SNS. For example, mixi has “Mixi Check” button, and Nintendo's Miiverse has “Yeah!” button. Although the description below is provided based on an assumption that the “Like” button is a “button I/F for easily expressing positive or favorable opinion”, the name can be changed depending on the SNS.

The tweet presentation unit 620 records, for each of the users, the view history (also referred to as view request history) for the tweets and stores the view history into the view history DB 618. The view history for tweets is an example of the behavior history information.

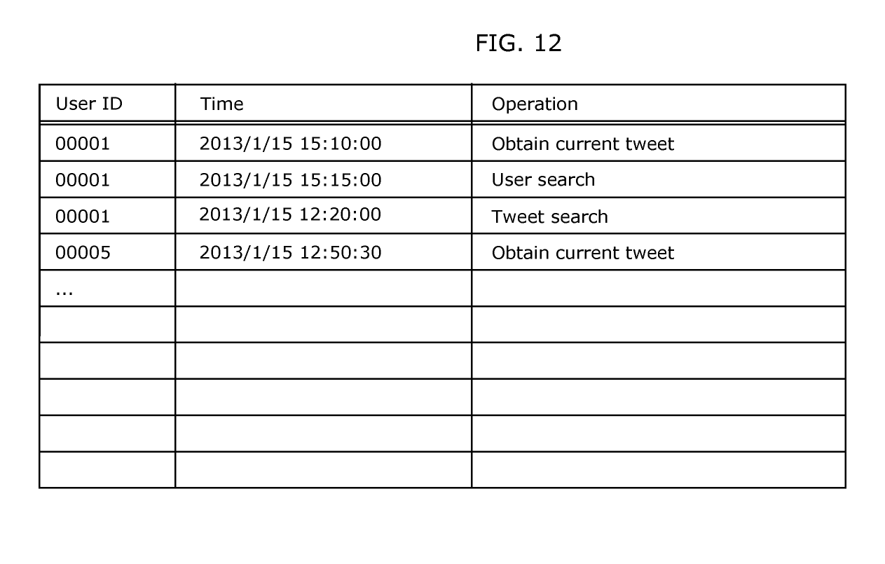

FIG. 12 indicates the data structure in the view history DB according to the embodiment.

FIG. 12 illustrates the configuration of the view history DB 618. The view history DB 618 records and manages the user ID, the time, and the operation, as a single entry.

The “user ID” is a user ID (user ID managed by the user-and-device management DB 617) of the user who has executed the viewing.

The “time” is a time at which the view operation is executed.

The “operation” indicates the operation content, and includes obtainment of current tweet, user search, tweet search, and tweet post, for example.

Referring back to FIG. 6, the tweet-generation-information setting unit 611 defines a tweet generation scheme for the tweet generation unit 614. The tweet generation scheme is an algorism for generating a tweet automatically.

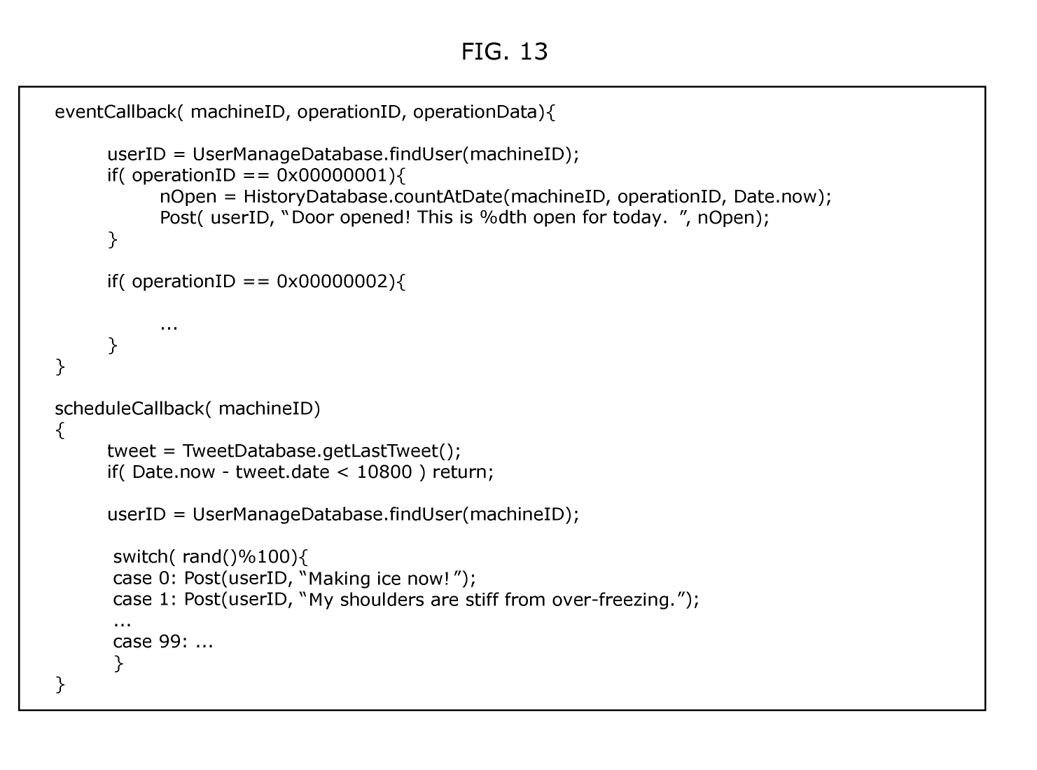

FIG. 13 illustrates a tweet generation scheme according to the embodiment.

An example of the above algorism is an algorism written in a programming language such as C language, as indicated in FIG. 13. The algorism is set for each product category ID. FIG. 13 indicates an example of the tweet generation scheme for the product category ID=0x0001 (refrigerator). As indicated in FIG. 13, two types of callback functions, namely eventCallback( ) and scheduleCallback( ) are prepared, and the user can define the tweet generation scheme by implementing these two functions using the tweet-generation-information setting unit 611. It is to be noted that eventCallback( ) and scheduleCallback( ) are mere example, and other callback may be defined. For example, a callback which occurs when the user accesses the tweet presentation unit 620 may be defined.

eventCallback( ) is a callback function executed at a timing when the device operation is performed. As an argument, machineID (device ID), operationID (operation ID), and operationData (operation information) are passed. The example in FIG. 13 indicates a case where the door of the refrigerator is opened and closed. UserManageDatabase in the first statement indicates a class object on a program of the user-and-device management DB 617. Use of this method allows accessing the database.

UserManageDatabase.findUser (device ID) is a method for searching and obtaining a user ID corresponding to a device ID, and passes the user ID as a return value. The first if statement is the operationID==0x0000001, and indicates a case where the door is opened.

HistoryDatabase indicates a class object on the program of the device operation history DB 612. Use of this method allows accessing the database. HistoryDatabase.countAtDate (device ID, operation ID, and date) is a method for counting how many times the operation indicated by the operation ID was executed on the device ID on the designated date. The result of the counted number is returned as a return value, and is stored in nOpen in the example in FIG. 13. The subsequent Post( ) function is a function for adding the tweet to the tweet DB 619 by the user ID. Post( ) is a function emulating the print statement in C language, and “% d” is a variable in decimal number. Post( ) generates a statement provided with a value of nOpen into “% d”, and adds the generated statement to the tweet DB 619. For example, when nOpen is 12, the statement is “Door opened! This is the 12th open for today.” As described above, defining the algorism in eventCallback( ) makes it possible to define the tweet generation scheme based on a device operation at the timing when the device operation occurs.

scheduleCallback( ) is a callback function executed as a regular timer event. As an argument, machineID (device ID) is designated. The time interval for the timer may be set depending on the system structure or by the tweet-generation-information setting unit 611. In the example in FIG. 13, the scheduleCallback function executes the method of TweetDatabase. TweetDatabase is a class object on the program of the tweet DB. Use of the above method allows accessing the database.

TweetDatabase.getLastTweet( ) is a method for obtaining the last tweet by the device, and the last tweet is replied as the return value. The replied last tweet is stored in “tweet” in the example in FIG. 13.

The statement “if (Date.now−tweet.date<10800) return” is a conditional statement which compares the generation time of the tweet and the current time. Data.now is the current time to the second, and tweet.date indicates the information on time to the second at which the last tweet is generated. By taking a difference between them, the time which has elapsed from the last tweet to the present is indicated. 10800 seconds are three hours. Thus, it is set that when the time elapsed from the last tweet to the present is less than three hours, nothing is executed and the program is finished. The above configuration allows adjusting the frequency of tweets.

The subsequent switch statement indicates that the content of the tweet is changed by a random number. The result of random numbers from 0 to 99 is calculated by rand( )%100, which allows providing a variation in a lot of tweets by changing the content of the tweet to be output depending on each case. As described above, defining the algorism in scheduleCallback( ) makes it possible for the device to define the generation scheme for tweets which are regularly generated by the device.

The tweet generation unit 614 processes the autonomous generation of tweets by the device, according to the tweet generation algorism set by the tweet-generation-information setting unit 611. Specifically, a thread of the program is executed by a unit of a device defined in the device management DB 622. In the executed thread, (1) eventCallback( ) is executed at a timing when the device operation occurs and (2) scheduleCallback( ) is executed per regular timer. In a time period other than the above, the tweet generation unit 614 is in a wait/idle state. The content of eventCallback( ) and scheduleCallback( ) is defined by the tweet-generation-information setting unit 611 as described in FIG. 13, and the tweet is added to the tweet DB 619 as a result of execution of this function. It is to be noted that the thread does not have to be executed by a unit of a device but may be executed by a unit of certain numbers of devices. It is to be noted that the thread to be executed may be limited to those connectable to the network out of the devices in the device management DB.

Furthermore, the tweet generation unit 614 may refer to the tweet registered in the tweet DB 619 and automatically generate a reply to the tweet by the device. Specifically, it is sufficient to obtain a tweet by a followee user of the device from the tweet DB 619, analyze the content of the obtained tweet, generate a reply tweet, and add the generated reply tweet to the tweet DB 619, in the generation of a tweet by scheduleCallback( ) and so on by the device.

Likewise, the tweet generation unit 614 may refer to the tweet registered in the tweet DB 619 and automatically cause the device to select the “Like” button to the tweet. Specifically, this can be implemented by obtaining the tweet of the followee user of the device from the tweet DB 619, analyzing the content, and adding the user ID of the device itself to the “Like User ID” of the tweet entry.

As described above, use of the device, the tweet generation-and-view server, and the tweet view device allows implementing the autonomous generation of tweets and viewing of generated tweets by the device. Next, based on the above configuration, description shall be provided on the scheme for reducing the load on a database in which the tweets are accumulated, by controlling the amount of tweets to be automatically generated by the device and without affecting the usability of the user who views the tweets.

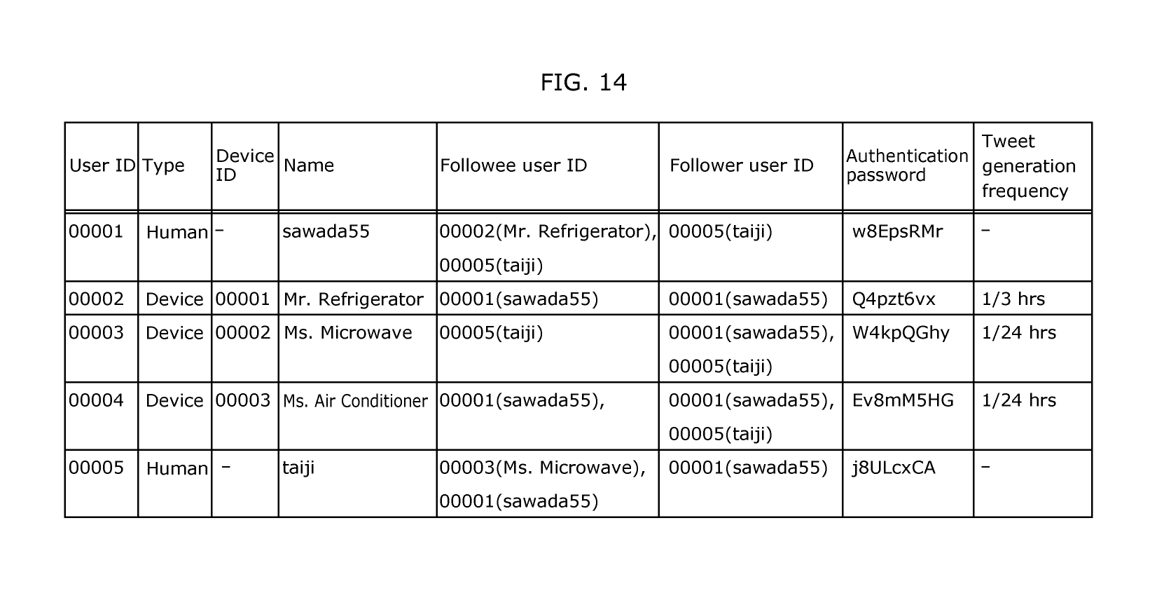

FIG. 14 illustrates a parameter on a tweet generation frequency according to the embodiment.

The tweet frequency calculation unit 616 calculates the tweet generation frequency and stores the calculated tweet frequency into the user-and-device management DB 617. FIG. 14 indicates the configuration of the user-and-device management DB 617. The attribute of the “tweet generation frequency” has been added to each entry in the configuration in FIG. 10. The tweet generation frequency of the device which is calculated by the tweet frequency calculation unit 616 is stored into the “tweet generation frequency”.

The tweet frequency calculation unit 616 calculates the tweet generation frequency by referring to the view history DB 618. Specifically, assume that the result of reference to the view history DB indicates that the user whose user ID=00001 (sawada55) views the tweets once a day on average, and that the user whose the user ID=00005 (taiji) views the tweets once in eight days on average, for example. In this case, the tweet frequency calculation unit 616 sets the tweet generation frequency of the followee user (device) of the user whose user ID=00001 (sawada55) high, and sets the tweet generation frequency of the followee user (device) of the user whose user ID=00005 (taiji) low. Since the user whose user ID=00001 (sawada55) follows the device whose user ID=00002 in the example in FIG. 14, a value of the tweet generation frequency of this device is set to ⅓ hours, for example. In contrast, the user whose user ID=00005 (taiji) follows the device whose user ID=00001. Thus, the value of the tweet generation frequency of this device is set lower than that of the followee device of the user whose user ID=00001 (sawada55), namely 1/24 hours, for example.

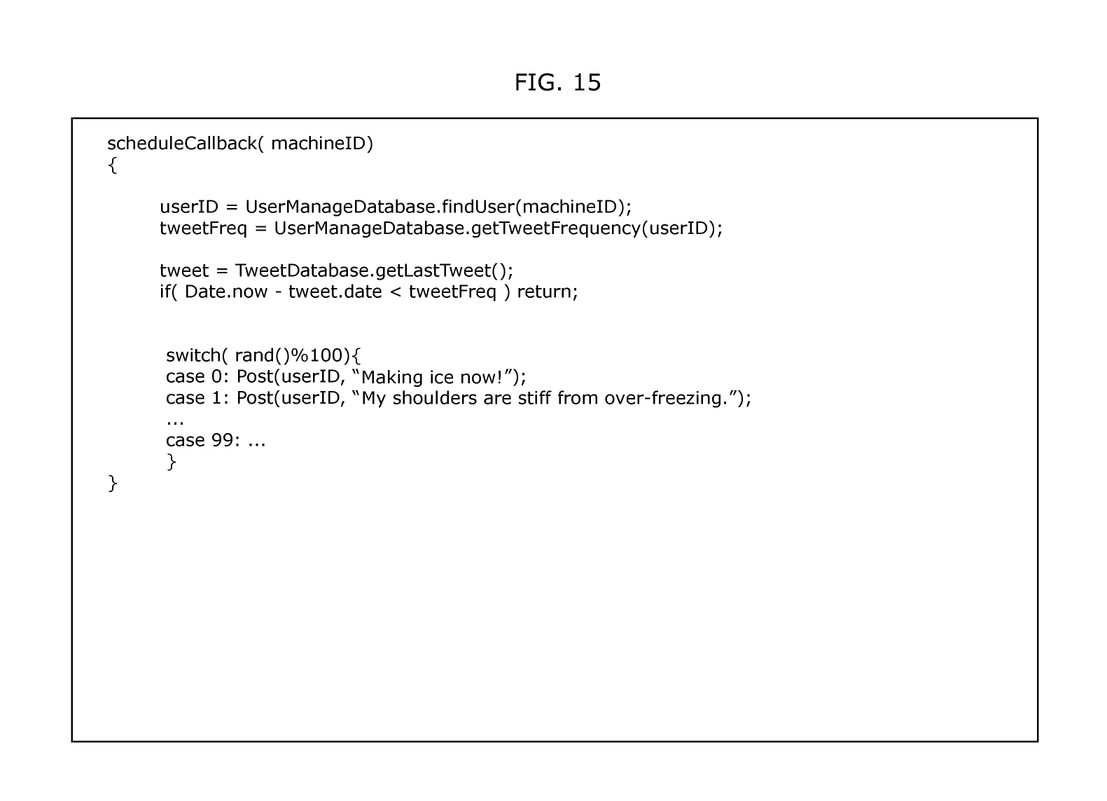

The tweet generation unit 614 generates the tweet by the device, based on the tweet generation frequency calculated by the tweet frequency calculation unit 616. Specifically, the timer interval for calling schduleCallback( ) may be set to this value, and the tweet generation frequency corresponding to the device may be obtained and the tweet generation frequency may be controlled by referring to the value using scheduleCallback( ) or eventCallback( ) as indicated in FIG. 15.

FIG. 15 illustrates a tweet generation scheme in which the tweet generation frequency is changed using a parameter on the tweet generation frequency, according to the embodiment. In the example in FIG. 15, the generation frequency is obtained by UserManageDatabase.getTweetFrequency (user ID). In the example in FIG. 15, the generation frequency is the average time interval taken for generating one tweet, and the generation frequency can be controlled by setting not to execute the tweet when the difference between the current time and the last tweet generation time is smaller than the interval.

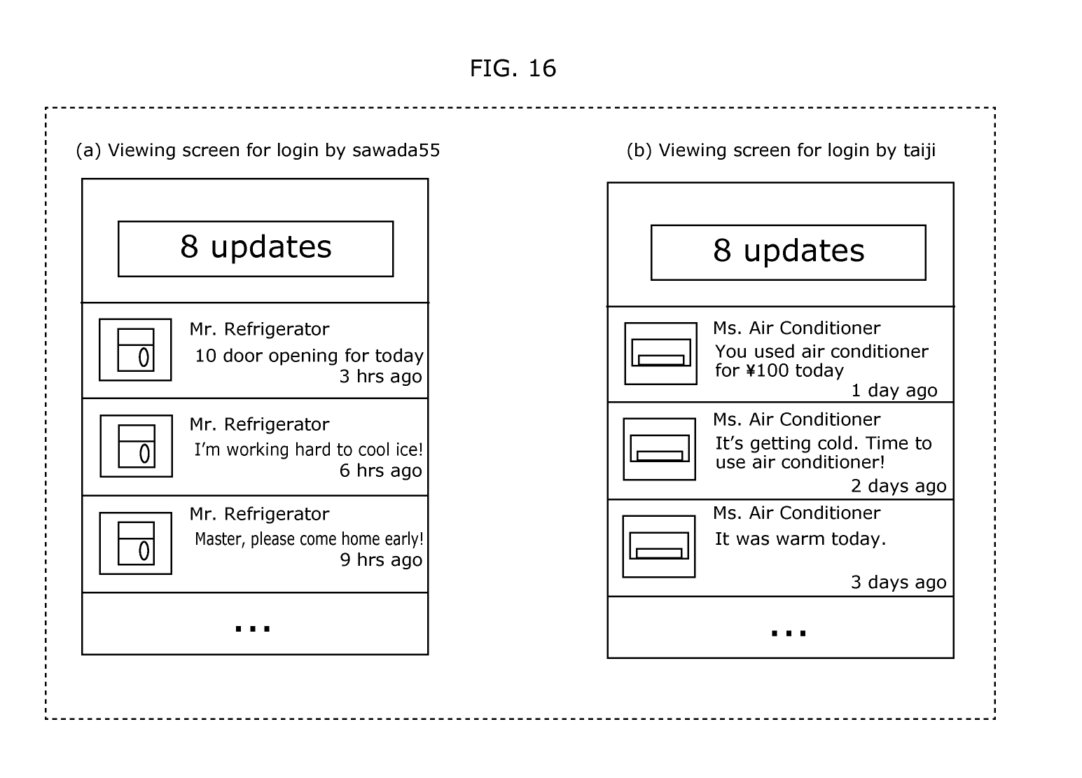

FIG. 16 illustrates display of tweet view result according to the embodiment. The result of display of tweet viewing by the user in the above manner is indicated in FIG. 16, for example. When sawada55 views tweets once a day on average and if the tweet frequency is set to ⅓ hours, average eight tweets are displayed at a time of user login when the number of followee devices is one. In contrast, when taiji views tweets once in eight days on average and if the tweet frequency is set to 1/24 hours, average eight tweets are displayed at a time of user login when the number of followee devices is one. Changing the number of tweets according to the view history of the user as described above allows setting to display the same number of new tweets at a time of user login, which does not affect the usability. It is to be noted that more natural tweets such as those by humans can be realized by providing some variation in the tweet generation timing, using the tweet frequency as an average value.

Such a configuration allows controlling the frequency of tweets automatically generated by each device, based on the tweet view history of the user. This makes it possible to control the amount of tweets automatically generated by the device, without affecting the convenience of the user who views the tweets.

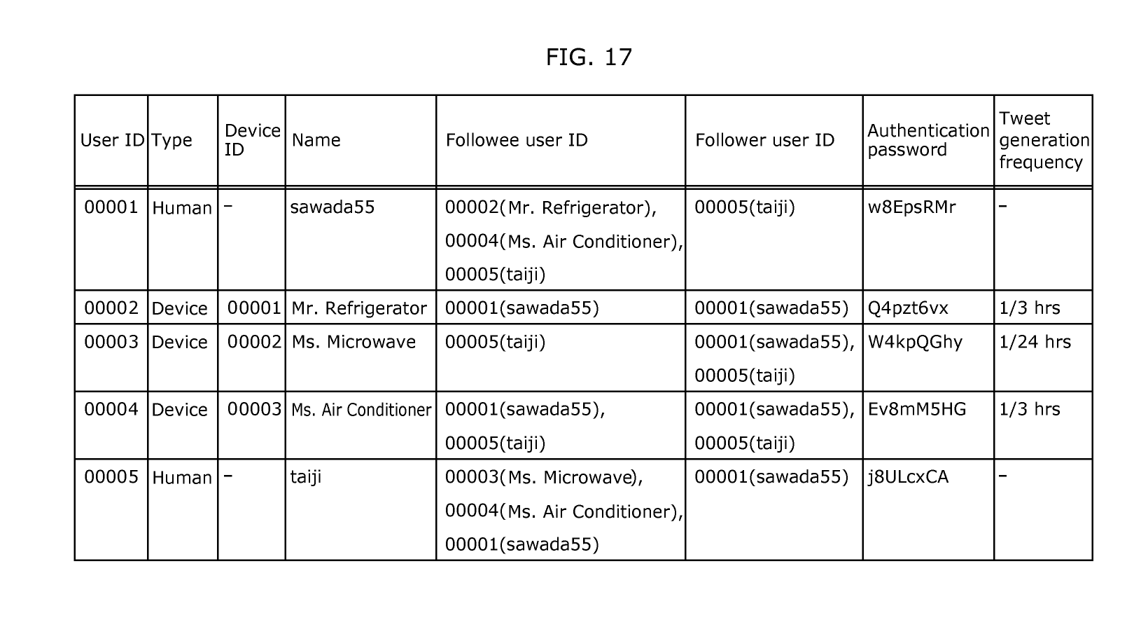

It is to be noted that, when users having different user IDs from each other follow devices having the same device ID as in FIG. 17, it is an option to set that the tweet generation frequency is determined based on the view history of the user who views tweets frequently. FIG. 17 illustrates another example of the user-and-device management DB according to the embodiment. With such a configuration, the usability of the user who accesses frequently is not affected.

It is an option to allow the tweet frequency calculation unit 616 to further set the “time period” as the calculation result, based on the tweet view history of the user. For example, when the tweet view history of the user indicates that the user often views tweets in a time period around noon, “morning” is set to the “time period” of the followee device of the user. Then, with the tweet generation scheme set by the tweet-generation-information setting unit 611, the device set with “morning” is caused to generate more tweets in the morning time period by referring to the current time. In contrast, when the tweet view history of the user indicates that the user often views tweets in the time period around midnight, “night” is set to the “time period” of the followee device of the user. Then, with the tweet generation scheme set by the tweet-generation-information setting unit 611, the device set with “night” is caused to generate more tweets in the night time period by referring to the current time. Such a configuration allows generating tweets in a timely manner according to the lifestyle of the user.

It is to be noted that the above “time period” may be designated as a time period from a start time to an end time, such as “from seven o'clock to eight o'clock”.

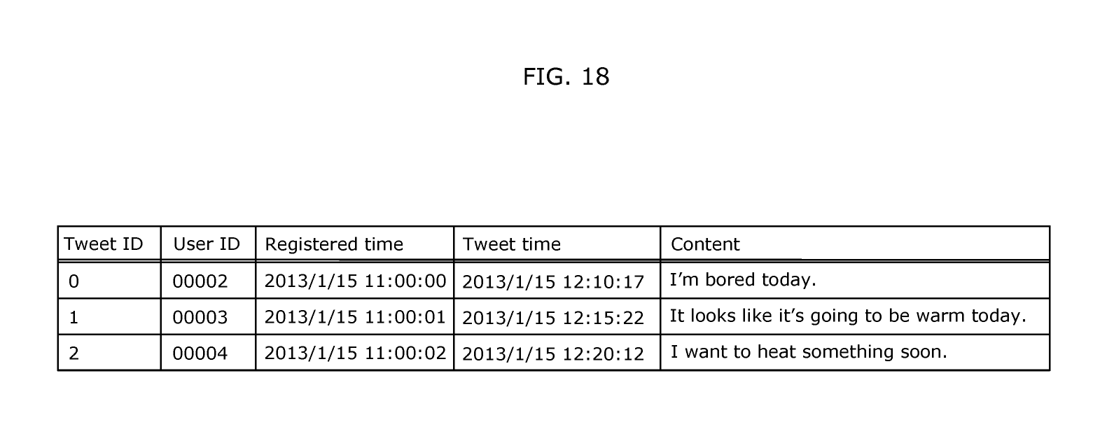

It is to be noted that the structure of data in the tweet DB may be managed by dividing the registration time to the database and the generation time of the tweet, as indicated in FIG. 18. FIG. 18 illustrates Modification 1 of the data structure in the tweet DB according to the embodiment. In this case, the tweet presentation unit 620 presents to the user the “tweet time” instead of the “registration time” to the database, as the time at which the user tweeted. When the user accesses the tweet presentation unit 620 before the “tweet time”, the tweet presentation unit 620 does not display the tweet and presents the tweet after the current time has passed the tweet time. Such a configuration allows the tweet generation unit to take into account or predict the load on itself, and schedule the tweet generation processing to the database. In other words, it becomes possible to smooth the processing load, by generating the tweet whose content is preliminarily known in advance at a timing when the processing load is low.

It is to be noted that when the registration time to the database and the generation time of the tweet are divided and managed as indicated in FIG. 18, a tweet whose “tweet time” is a time preceding the current time may be generated and presented to the user, at a timing when the user accesses the tweet presentation unit 620. Such a configuration makes it possible to reduce the tweet generation frequency of the device to the user who does not access the tweet presentation unit 620 frequently. In other words, the tweet generation unit can stop generating tweets by devices to the user who does not accesses the tweet presentation unit 620 frequently, and generate and present previous tweets as the current tweets only when the user accesses the tweet presentation unit 620.

Although it has been described that the tweet frequency calculation unit 616 performs calculation based on the tweet view history of the user, not the tweet view history but the use history of the device may be used. For example, when there is a user who uses a vacuum cleaner once a month and a user who uses a vacuum cleaner once a week, the tweet generation frequency to the user who uses a vacuum cleaner once a week may be increased. This allows generating tweets in response to the interest of the user, since the user who uses a device frequently generally has a strong interest to the device.

Although it has been described that the tweet frequency calculation unit 616 performs calculation based on the tweet view history of the user, not the tweet view history but the use history of other devices or a result of sensor may be used. For example, when an alarm clock is connected to the tweet generation-and-view server 601 as the device, ON and OFF, which are the operation history of the alarm clock, are accumulated to the device operation history DB 612. By referring to this value, the sleep rhythm of the user who owns or holds the alarm clock can be found. Thus, the tweet frequency calculation unit 616 refers to the operation history of the alarm clock and determines the tweet frequency (generation frequency and time period). This allows generating tweets having content in response to the situation of the user in a timely manner, according to the user's rhythm of life. For example, it becomes possible to generate a tweet including an inquiry to the user while the user is awake. It is to be noted that the alarm clock is an example, and if the tweet generation-and-view server 601 can obtain log information such as a graph of power consumption at a house, the generation timing and content of the tweet can be controlled to be more suitable for the user based on such information. It is to be noted that the “tweet including an inquiry to the user” is called “first-type content” and content other than the first-type content is called “second-type content”, in some cases.

Although it has been described that the tweet frequency calculation unit 616 performs calculation based on the tweet view history of the user, not the tweet view history but a tweet post frequency may be used. For example, the frequency of tweet by a device to the user having a low post frequency may be lowered. In other words, the tweet frequency of a device to the user having a high post frequency may be increased. This allows tweet frequency that suits the preference of the user.

It is an option to make an actual operation of the device executable by the user replying to the tweet generated by the device.

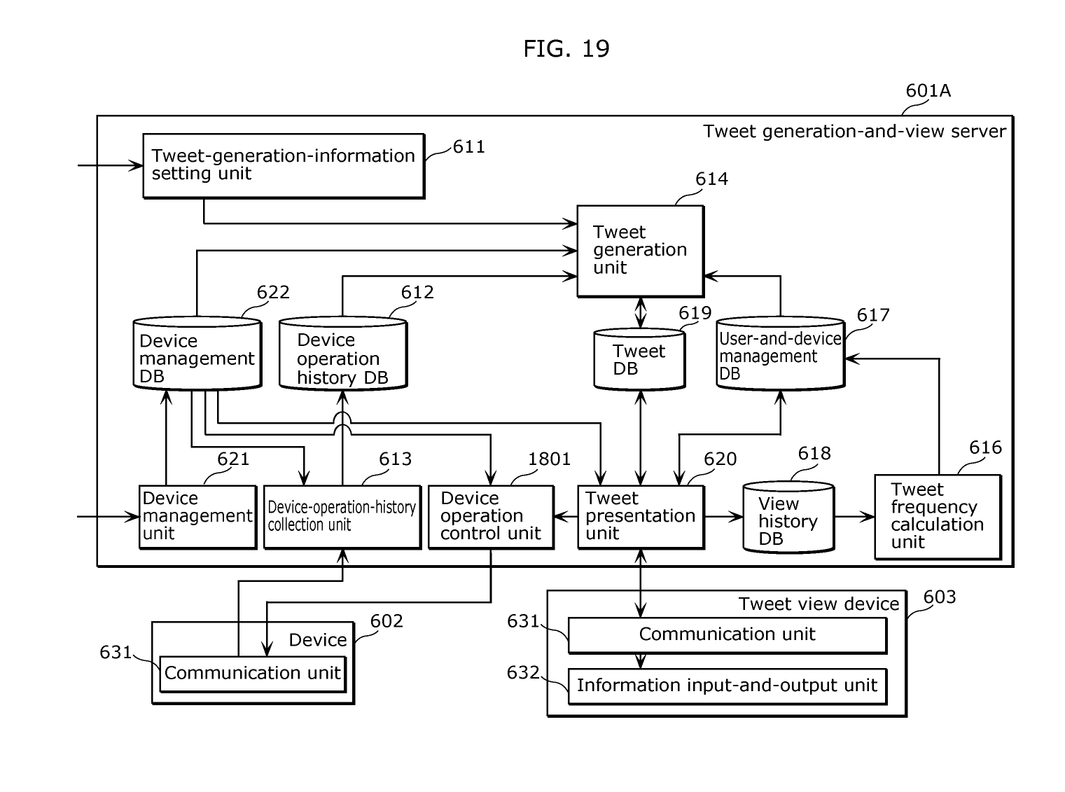

FIG. 19 is a block diagram illustrating a modification of a content generation-and-view system according to the embodiment. The tweet generation-and-view server 601A indicated in FIG. 19 includes a device operation control unit 1801, in addition to the tweet generation-and-view server 601. The device operation control unit 1801 communicates an “operation command” to the device in response to the command from the tweet presentation unit 620. The device 602 receives the “operation command” from the communication unit 631, and executes the device operation on itself.

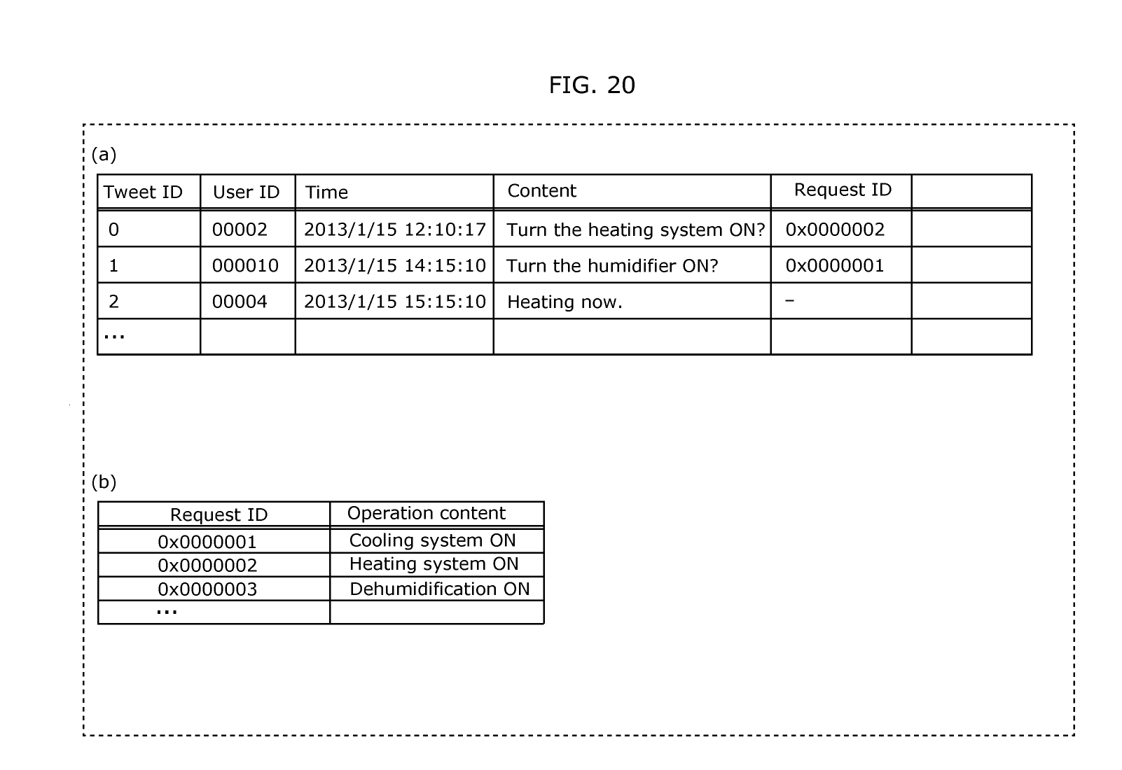

The details shall be described below. As indicated in FIG. 20, an attribute of the request ID is added to the tweet DB. The request ID is an ID of a request parameter defined for each of the product categories. The request ID defines, by referring to the request parameter definition, the content of operation to be performed after the user has replied.

Specifically, in the example of the tweet ID=0 in the tweet DB in (a) in FIG. 20, the tweet by the air conditioner designates the request ID=0x00000002 along with the text inquiring “Turn the heating system ON?”. By referring to the request parameter definition in (b) in FIG. 20, it can be found that the request ID=0x00000002 is heating system ON. When the inquiry is for recommending processing on the device, the tweet generation unit 614 sets, as the content of operation to be performed when replying to the user, the request ID simultaneously with the tweet message. Such a tweet with the “request ID” is defined as an “operation recommendation tweet”.

When the tweet presentation unit 620 presents a tweet inquiring “Turn the heating system ON?” by the air conditioner to the user and the user replies “Yes” to this request, the tweet presentation unit 620 transmits the device ID of the air conditioner and the request ID to the device operation control unit 1801. The device operation control unit 1801 (i) generates an operation command for causing the air conditioner, which is the device identified from the device ID, to work in response to the request ID and (ii) transmits the generated operation command to the air conditioner. The air conditioner executes the transmitted operation command. The operation command is written using the operation parameter definition as described in FIG. 9, for example. When the user replies “No” or does not reply to the operation recommendation tweet, the tweet presentation unit 620 does nothing to the device operation control unit 1801.

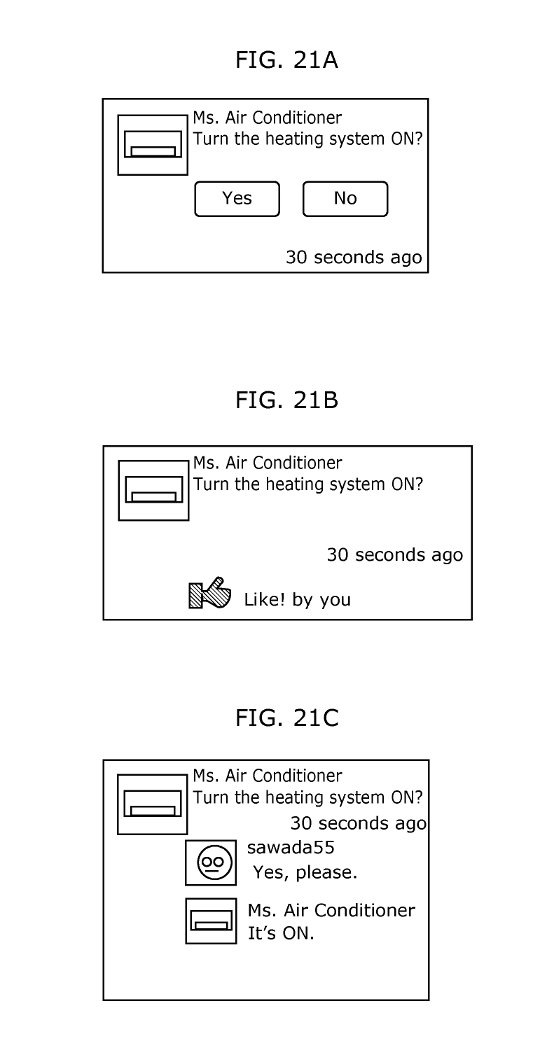

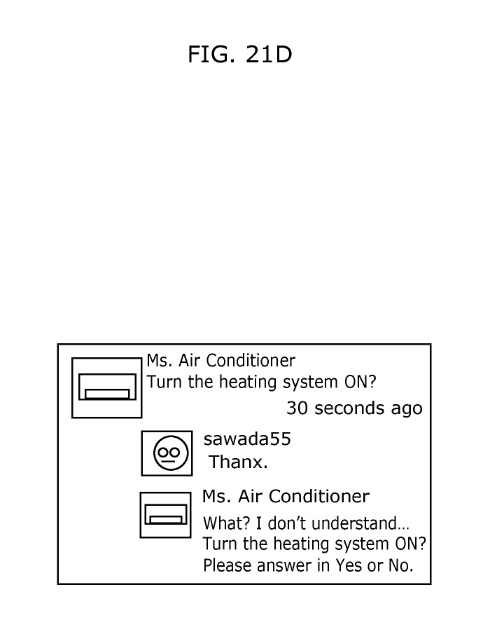

Each of FIG. 21A to FIG. 21D illustrates a display example of the operation recommendation tweet.

In the operation recommendation tweet, selections of answers by the user may be presented in the tweet display as in FIG. 21A. This allows correctly reflecting the intention of the user.

In the operation recommendation tweet, the “Like” button and so on may be displayed in the tweet display as in FIG. 21B. The tweet presentation unit 620 may process the pressing of the “Like” button by the user as expression of positive intension by the user. This allows the user to easily express the intention through the SNS user interface.

In the operation recommendation tweet, the operation result may be displayed as in FIG. 21C. This allows the user to confirm that his/her intended operation has been surely executed by the device.

In the operation recommendation tweet, a confirmation message may be presented as in FIG. 21D. When the reply from the user cannot be analyzed correctly, the tweet presentation unit 620 may generate the tweet again to present the confirmation message. This prevents an erroneous operation which is different from the intention of the user.

It is to be noted that the operation recommendation tweet may be generated based on the use history of other devices or the result of the sensor. For example, when GPS information of the smartphone of the user is collected and it is detected that the user is coming home from outside, an operation recommendation tweet by a device may be generated based on the history of operation on the device executed by the user after coming home. As a specific example, when it is detected that the user is coming home, the air conditioner generates, based on the device operation history of the user, an operation recommendation tweet inquiring “Turn the air conditioner On?”.

As a specific configuration, the tweet generation unit 614: obtains GPS information of the smartphone of a user who follows the device in the tweet generation processing such as scheduleCallback( ) and when detecting that the user is coming home from outside, refers to the device management DB 622 and the device operation history DB 612, identifies the operation information (operation ID) which the user is likely to execute after coming home, generates an operation recommendation tweet, and registers the generated operation recommendation tweet into the tweet DB 619.

In the case where an operation recommendation tweet was generated but the recommended device operation has already been executed by a remote controller and so on at a timing when the user views tweets, presenting the user with the operation recommendation tweet as it is may confuse the user. Thus, the following options are available.

(1) When the operation recommendation tweet is not viewed by the user and the operation has already been executed, the tweet may be discarded. Specifically, in the case where: the view request from the user is accepted; a new tweet from the tweet DB is obtained; the obtained new tweet is an operation recommendation tweet; and it can be found by referring to the device operation history DB 612 that the operation has already been executed, the tweet presentation unit 620 may delete the operation recommendation tweet from the tweet DB.

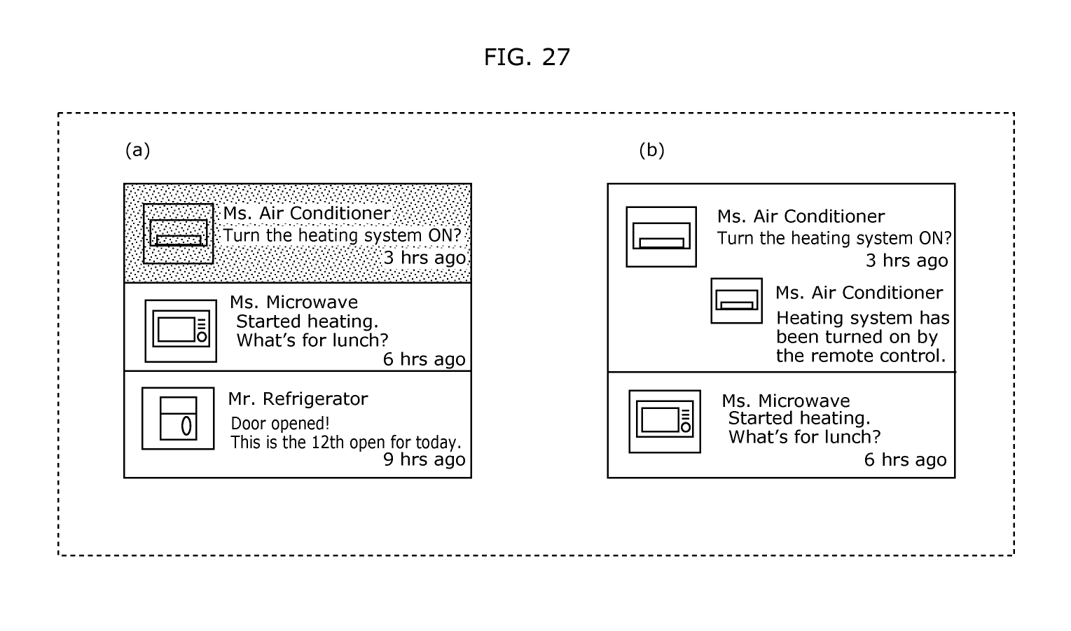

(2) When the operation recommendation tweet is not viewed by the user and the operation has already been executed, display of the tweet may be changed. Specifically, in the case where: the view request from the user is accepted; a new tweet from the tweet DB is obtained; the obtained new tweet is an operation recommendation tweet; and it can be found by referring to the device operation history DB 612 that the operation has already been executed, the tweet presentation unit 620 presents display of the operation recommendation tweet in a different manner. It is to be noted that the tweet display changing scheme includes a scheme for graying the tweet as in (a) in FIG. 27, for example.

(3) When the operation recommendation tweet is not viewed by the user and the operation has already been executed, another tweet may be sent in reply to the tweet as a post follow-up. In the example in (b) in FIG. 27, a reply saying “The heating system has been turned on by the remote control.” is sent to follow up the operation recommendation tweet inquiring “Turn the heating system ON?”. Specifically, in the case where: the view request from the user is accepted; a new tweet from the tweet DB is obtained; the obtained new tweet is an operation recommendation tweet; and it can be found by referring to the device operation history DB 612 that the operation has already been executed, the tweet presentation unit 620 notifies the tweet generation unit 614 of an event. The tweet generation unit 614 generates a reply tweet to the operation recommendation tweet and registers the generated reply tweet into the tweet DB.

The above configuration allows preventing user confusion even when an operation recommendation tweet was generated but the recommended device operation has already been executed by the remote controller and so on at a timing of the user's viewing the tweet. It is to be noted that the options (1) to (3) may be executed not only when the tweet is not viewed by the user and the operation has been executed, but also when a certain time period has elapsed since the “operation recommendation tweet”, for example. In this case, a parameter for a “valid period” of the “operation recommendation tweet” is set and registered into the tweet DB. In the case where the valid period has passed at a timing of the user's viewing the tweet, the tweet presentation unit 620 can be provided by setting to perform the above options (1) to (3).

It is to be noted that the generation frequency for the operation recommendation tweet may be lowered as the view frequency by the user is lower. This is because a user whose view frequency is low is not likely to view the operation recommendation tweet within the valid period.

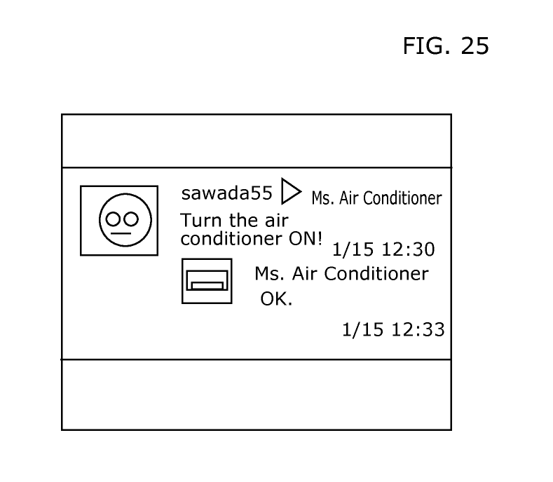

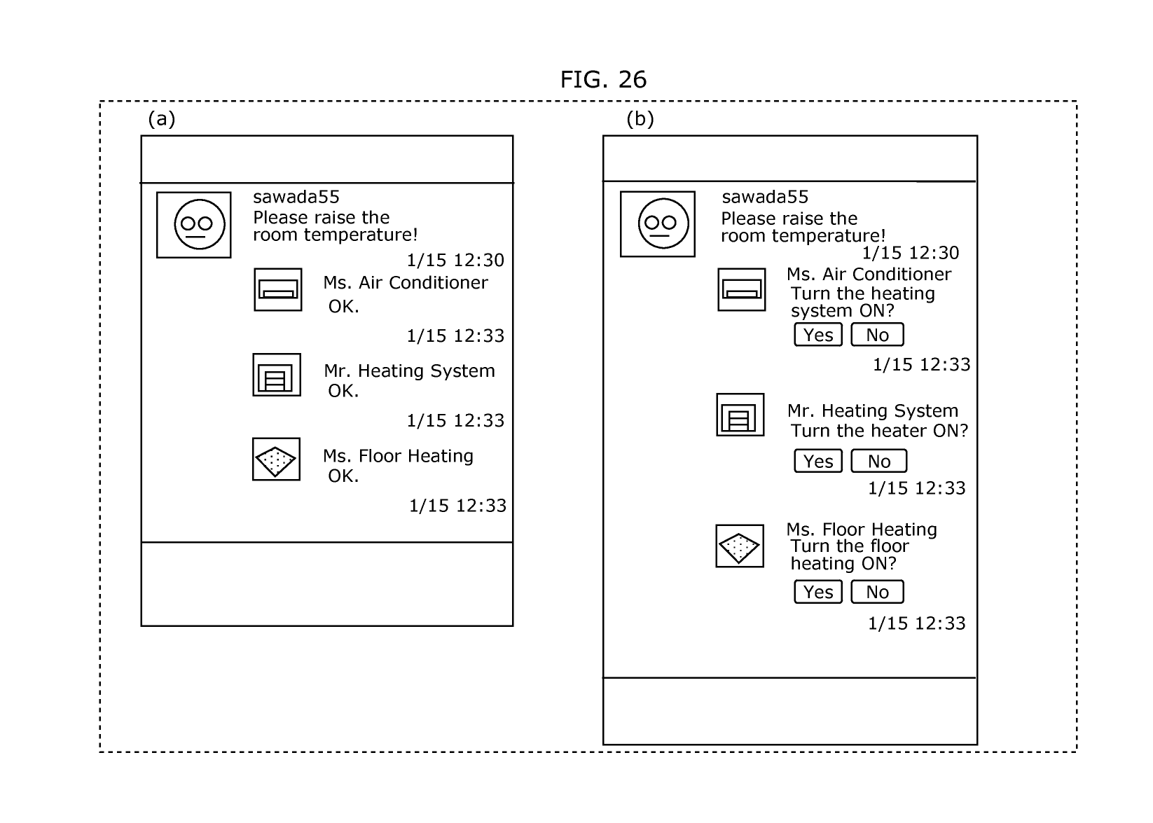

Although it has been described in the operation recommendation tweet that the operation of the device is provided by the user's reply, the user may request the operation to the device directly by tweeting to the followee device. In this case, the tweet presentation unit 620 analyzes the tweet by the user to the device, identifies the request ID from the request parameter definition of the device, and transmits the device ID and the request ID to the device operation control unit 1801. After that, the tweet presentation unit 620 notifies the tweet generation unit 614 of the event, and the tweet generation unit 614 generates a reply tweet in response to the event notification and registers the generated reply tweet into the tweet DB. The tweet for requesting an operation to the device as described above is defined as an “operation request tweet”. An image of the user interface for the operation request tweet is indicated in FIG. 25. Such a configuration allows the user to easily control the operation of the device by the tweet I/F.

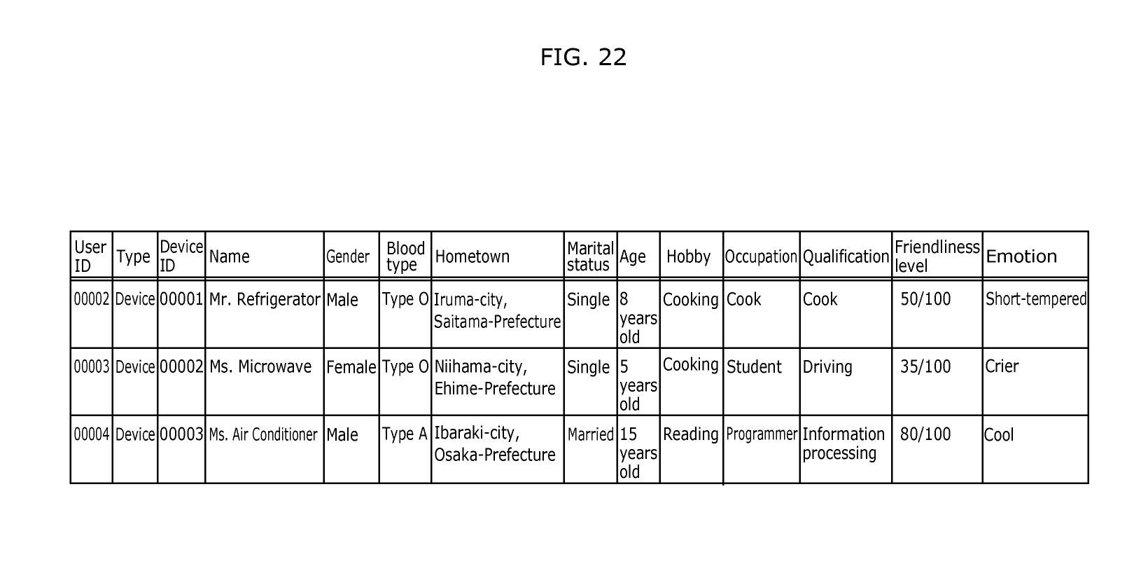

Regarding the tweet by the device, it is an option to set a human-like character to each device as a parameter, to provide various tweets to the user so that the user does not get bored. Specifically, the user-and-device management DB is configured as in FIG. 22 and each entry is set with parameters such as gender, blood type, hometown, marital status, age, hobby, occupation, qualification, friendliness level, and emotion. Each parameter may be set automatically from the profile and so on of the device, or may be changeable through the GUI and so on by the user who owns the device, as appropriate.

When generating a tweet by the device, the tweet generation unit 614 changes the content (comment) of the tweet by referring to these parameters. An example of the content change shall be described below.

The tweet generation unit 614 changes the comment to manly expression (“I'm feeling cool today!”) when the “gender” is set to male, and to feminine expression (“I'm feeling fine today!”) when the “gender” is set to female.

The tweet generation unit 614 changes, based on the character, the comment to a sensitive comment when the “blood type” is set to A, and to a sloppy comment when the “blood type” is set to O.

The tweet generation unit 614 applies dialects of each area to the comment, according to the “hometown”. The comment is changed to the standard Japanese language when the hometown is set to Saitama, and changed to Kansai dialect when the hometown is set to Osaka. The actual site of manufacture may be set as the parameter for hometown. In this case, it is sufficient that the tweet generation unit 614 obtains and sets the attribute information of the device management DB 622.

The tweet generation unit 614 may set, to the “marital status”, whether the user is single or married, or married to which partner. Married partners may have harmonious conversation, or have quarrels each other.

The tweet generation unit 614 changes comments to a childish expression when the “age” is set to low, and to a mature expression when the “age” is set to high. The number of years from the time of purchase or manufacture of the actual device to the present may be set as the parameter for the age. In this case, it is sufficient that the tweet generation unit 614 obtains and sets the attribute information in the device management DB 622.

The tweet generation unit 614 obtains information on the hobby or qualification according to the “hobby” or “qualification” through web search and so on, and changes comments based on the obtained information.

The tweet generation unit 614 may change the way of speaking in the comment according to the “friendliness level”. Here, the “friendliness level” indicates how friendly the user and the device are. The tweet generation unit 614 speaks casually when the “friendliness level” is set to high, and speaks politely other than the above case. This allows more human-like communication between the user and the device. It is an option to allow separately setting the “friendliness level” for the followee users of the device. In this case, the way of speaking or the content may be changed according to the friendliness level between a device and the user who speaks to the device, and in the “operation request tweet” to the device, the probability of operation execution may be changed according to the friendliness level. Specifically, the device may willingly execute a request from a user whose friendliness level is high but decline a request from a user whose friendliness level is low.

The tweet generation unit 614 may change the content of the comment according to the “emotion”. The “emotion” indicates characteristics of human feelings such as short-tempered or crier.

The above configuration allows the tweet generation unit 614 to provide the user with a variety of tweets.

As for the relationship between the user and the device, it is an option to set “family relationship” or “friend relationship”. In other words, the user may be allowed to set to the device with attributes such as “son”, “daughter”, “husband”, “wife”, “cousin”, “boyfriend”, “girlfriend”, “best friend”, and so on. If the wording is changed based on these attributes, a more human-like communication can be established between the user and the device. For example, the device set as “girlfriend” may generate a sweet tweet such as “I feel tired (heart).” The relationship between the user and the devices may be displayed as a GUI by a social graph or a family tree based on these attributes, for example.

The “friendliness level” may be set not only between the device and the user but also between the devices. In this case, tweets may be generated in a manner that devices having high friendliness levels talk (reply) to each other on their own. In contrast, tweets may be generated in a manner that devices having low friendliness levels quarrel each other.

The “friendliness level” may be set not only between the device and the user but also between the devices. In this case, it is an option to set devices having high friendliness levels to generate “Like” to each other often.

It is to be noted that the value of the friendliness level between devices may be set high for devices in the same category. An example of this is: the microwave and the refrigerator are good friends since they both deal with food items, or the TV and the recorder are good friends since they both deal with video. This allows the user to understand the friendliness level of the devices intuitively.

It is to be noted that the value of the friendliness level between devices may be set high between devices which are used in the same timeslot. For example, the microwave and the refrigerator are good friends since they are likely to be used at the same time, and the TV and the recorder are good friends since they are likely to be used at the same time. This allows the user to understand the friendliness level of the devices intuitively.

The tweets generated by the device may be exaggerated to attract attention of the user. For example, if a humidifier tweets “I'm dying for water.”, the user is given a start and pays attention on the humidifier. In order to make the tweet from the device more human-like, it is an option to set the device to tweet something different from the truth, or tell a lie, only occasionally. If the device does so on April Fool's day (April first), this can be a fun humor to the user.

It is to be noted that “proficiency” may be set for the user-and-device management DB 617. The proficiency indicates a success rate in processing of operation request for the “operation recommendation tweet”. It is an option to set a device with a low proficiency to sometimes fail processing even when an operation is requested, and the success rate increases when the proficiency is increased. The above configuration allows providing a user with fun as if the user is playing a caring game for increasing the proficiency.

As a modification of the “operation request tweet”, the device may be set to, when a request is received without designating a device, automatically execute the request. For example, when the user asks “Please raise the room temperature.” as in (a) in FIG. 26, the air conditioner, the fan heating system, and the floor heating device voluntarily execute the operation.

Specifically, the tweet presentation unit 620 analyzes the operation request tweet from the user and identifies the available device ID. After that, the tweet presentation unit 620 identifies the request ID from the request parameter definition of one or more device IDs, and transmits the device ID and the request ID to the device operation control unit 1801. After that, the tweet presentation unit 620 notifies the tweet generation unit 614 of the event. The tweet generation unit 614 generates a reply tweet by the device in response to the event notification, and registers the generated tweet into the tweet DB. The above configuration allows the user to cause a device to execute his/her request easily without identifying the device.

As shown in (b) in FIG. 26, it is an option to cause the device not to execute the request immediately after receiving the request but to confirm with the user whether to execute the operation. The above configuration allows preventing a device not intended by the user from executing the operation.

Furthermore, to the tweet generated by the user, the folowee devices of the user may estimate an operation the user may want to be executed and generate an “operation recommendation tweet”. For example, when the user tweets “I'm going home now”, the air conditioner followed by the user may tweet “Turn the heating system ON?” and the light followed by the user may tweet “Turn the light ON?”. The above configuration allows the user to execute the device operation easily without difficult control. Specifically, the tweet generation unit 614 obtains a tweet by the follower user of the device in the tweet generation processing such as scheduleCallback( ) analyzes the content and identifies the current behavior of the user, refers to the device operation history DB and identifies an operation of the device required in the behavior, generates an operation recommendation tweet, and registers the generated tweet into the tweet DB.

The same control as the above can be performed using information including the position information of the user, instead of the user's tweet described above. The position information of the user can be obtained through Global Positioning System (GPS) and so on. It is to be noted that the position information of the user is an example of the behavior history information of the user.

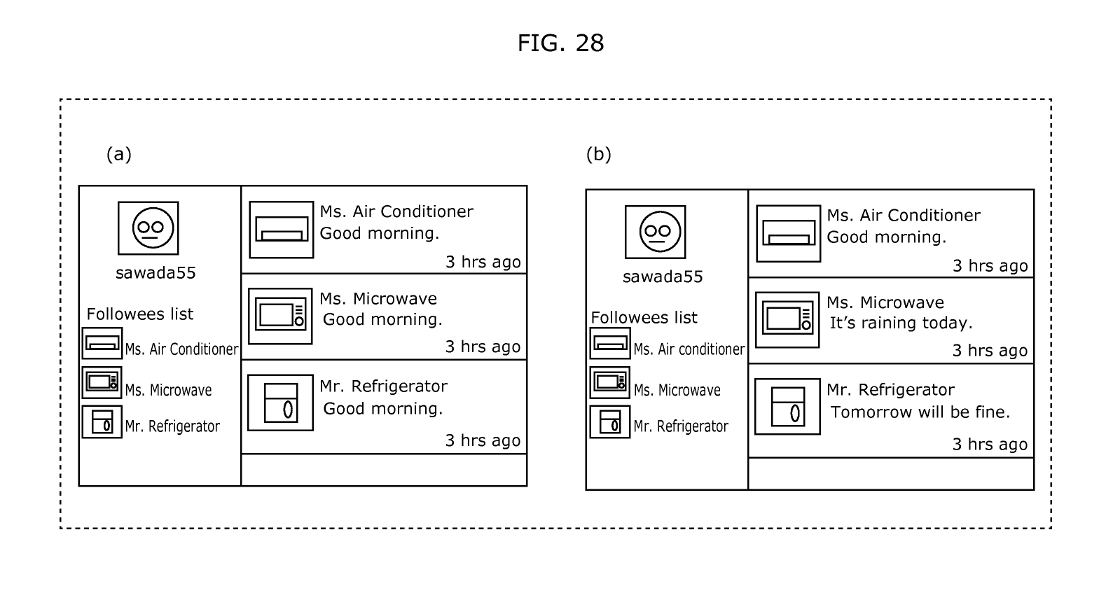

Regarding a tweet generated by the device, the content of the tweet may be adjusted among the followee devices of the user, to avoid redundancy of the content with other followee devices of the user. In the example in (a) in FIG. 28, all of the devices followed by the user tweet “Good morning”. However, when all of the devices tweet the same content, it is not interesting for the user. Thus, as shown in (b) in FIG. 28, the devices are set to tweet different content. This can be provided by referring to the content of the current tweets by the devices held by the follower user in the tweet generating processing by the tweet generation unit 614, and generating a tweet to avoid redundancy.

Although the tweet generation scheme by the device used by the user is described in the embodiment, a tweet by a device currently not held by the user may be provided. For example, a tweet by a product may be generated at a time when the user purchases the product through a layaway plan on the Internet. A tweet on a status of delivery may be generated such as “I'm coming to your home!” This can be provided by registering the device into the device management DB 622 and the user-and-device management DB 617 and appropriately defining the tweet generation scheme for the tweet generation unit 614, at a time when the user purchased the product on the layaway plan on the Internet and so on.

When a device is broken and becomes unusable, it is an option to allow changing the device ID of the entry corresponding to the user ID of the broken device (ID managed by the user-and device manage DB 617) to the device ID of the newly purchased device, to prevent the user who has got into the device from feeling lonely. The above configuration allows succeeding the previous tweets by the broken device, which allows the user to avoid lonely feeling.

As the attribute of the tweet DB, a privacy attribute may be defined for designating a user who is allowed to view the tweet. When this attribute is set, users other than the designated user may be prohibited from viewing the tweet generated by the device. For example, regarding a tweet from a weight scale, the privacy attribute is set for information on tweets which the user does not want to be viewed by other users such as the weight of the user, to allow only the user to view the information. In contrast, the privacy attribute is not set for tweets on how to use the weight scale. The above configuration allows flexible privacy setting for the tweets from devices.

The following is a variation in tweets generated by the device.

(1) The device searches the Internet for news related to the device and generates a tweet including the content of the news (URL or tweet on Twitter). For example, the refrigerator may tweet know-how information on the device such as: “I will tell you how to tidy the items in the refrigerator! (http://xxx . . . /)”.

(2) The device captures and uploads a photo and generates a tweet including the link to the photo. For example, the refrigerator tweets: “What's inside the refrigerator now (http://xxx . . . / . . . jpg)”.

(3) A home appliance generates a tweet on a commercial (CM) according to the type and the use history of the device held by the user. For example, to a user who does not have a microwave, a refrigerator tweets: “A brand-new microwave from M company is now on sale (http://xxx . . . / . . . jpg)”.

(4) A home appliance generates a tweet on “unused function” according to the use history of the device held by the user. For example, to a user who has not pressed a “milk button” of a microwave, the microwave tweets: “You can make super-tasty hot milk by pressing the milk button of the microwave.”

The above can be provided by defining the tweet generation scheme for the tweet generation unit 614 by a program as described above.

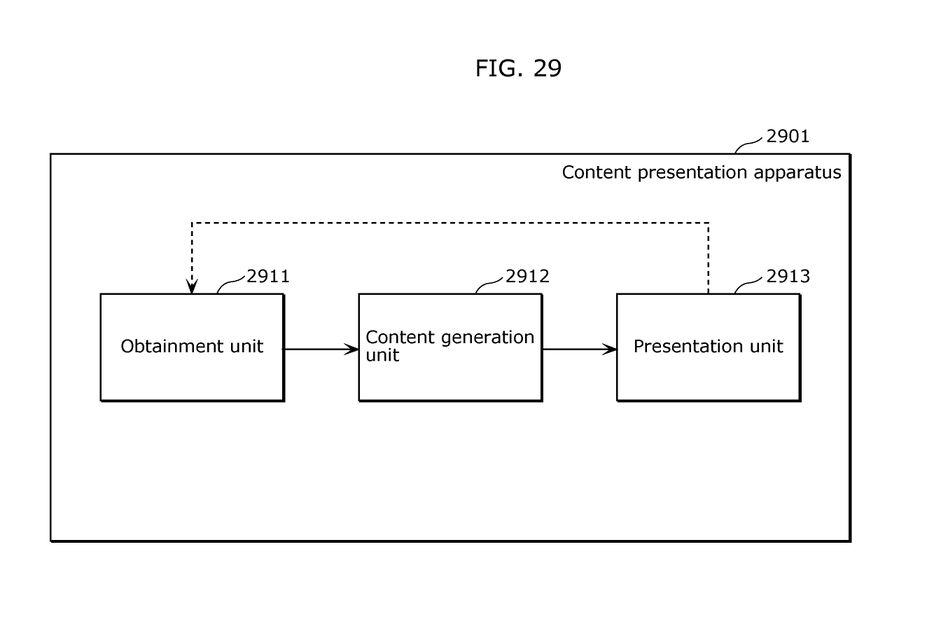

FIG. 29 is a block diagram illustrating another example of the configuration of the content presentation apparatus according to the embodiment.

As illustrated in FIG. 29, the content presentation apparatus 2901 includes: an obtainment unit 2911 that obtains the behavior history information of the user of the device; a content generation unit 2912 that determines the frequency for generating content for interaction with the user made by the device based on the behavior history information and generates content at the determined frequency; and a presentation unit 2913 that presents the user with the content by casing the server for distributing content for interaction to distribute the generated content as the content for interaction.

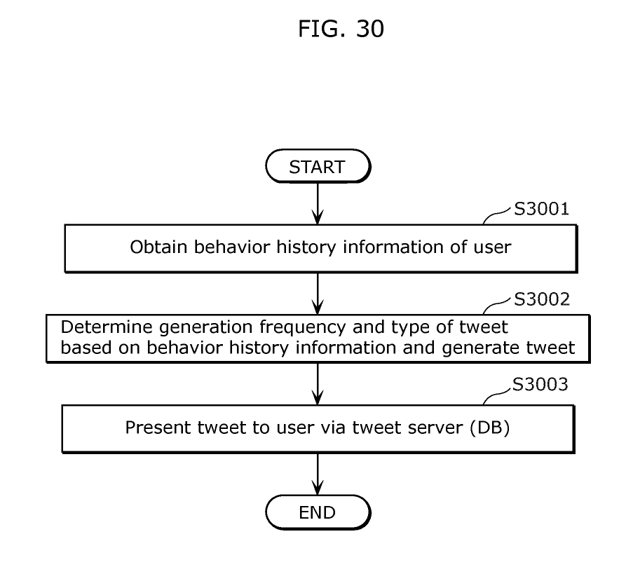

FIG. 30 is a flowchart illustrating another example of the content processing scheme of the content presentation apparatus according to the embodiment.

As illustrated in FIG. 30, the content presentation method includes: obtaining behavior history information of a user (S3001); determining a frequency for generating content based on the behavior history information and generating the content at the determined frequency (S3002), the content being for interaction with the user made by a device; and presenting the generated content to the user by distributing the generated content (S3003).

As described above, with the content presentation method according to the embodiment, the type and the frequency of content related to the device is determined based on the behavior history information of the user. Specifically, the type and the generation frequency of the content are determined according to the probability that the user views the content. The probability is determined from the behavior history of the user. Thus, with the content presentation method according to the present invention, the processing load on the server can be reduced without affecting the usability.

Furthermore, the type of the device-related content is determined based on the behavior history information of the user. Specifically, the type of the content is determined according to the probability that the user views the content. The probability is determined from the behavior history of the user. Thus, with the content presentation method according to the present invention, the processing load on the server can be reduced without affecting the usability.

Furthermore, less content items are presented to the user whose frequency of view request for content items is less. This allows reducing the content items which the user should view at once according to the view frequency of the user, which keeps the number of content items which the user should view at once approximately constant, irrespective of the view frequency. Thus, it is possible to reduce the processing load on the server without affecting the usability.

Furthermore, this allows presenting less content items in a time period (first time period) in which the frequency of view request for content item by the user is low. Thus, the generation frequency of content items is reduced in the time period in which the probability that the user views the content item is low, and the generation frequency of content items is maintained in the time period in which the probability that the user views the content item is high. Thus, it is possible to reduce the processing load on the server without affecting the usability.

This allows reducing the generation frequency of content items including an inquiry to the user whose frequency of view request for content items is low. This is because, it is inferred that even when a content item including an inquiry is presented to the user whose frequency of content view request is low, relatively long time elapses before the user views the content item and it is likely that an appropriate device control cannot be performed even when an answer to the inquiry is obtained at that timing. When it is assumed that the appropriate control cannot be performed as a result of viewing the content item by the user, generation frequency of content items is reduced.

This allows presenting less number of content items to the user whose frequency of operation to the device is low. Thus, the content items which the user should view at once are reduced according to the frequency of operation by the user. Thus, it is possible to reduce the processing load on the server without affecting the usability.

Furthermore, this allows reducing generation frequency of content items in the time period (second time period) in which the user has operated the device, and maintaining generation frequency of content items in the third time period. Since it can be predicted that the user is likely to control the device in the third time period in the future, generating and presenting the content items in the third time period allows reducing the number of content items without affecting the convenience of the user.

Furthermore, this allows reducing the generation frequency of content items including an inquiry to the user whose frequency of operation to the device is low. With this, the number of content items can be reduced without affecting the convenience of the user.

Furthermore, the generation frequency of content items is reduced when the user is not in a preset region, and the generation frequency of content items is maintained when the user is in the region. Thus, it is possible to reduce the processing load on the server without affecting the usability.

The technique in the above-described aspects may be implemented in, for example, the following types of cloud services. It should be noted that implementation of the technique described in the above the embodiment is not limited to these types.

### (Service Type 1: Own Data Center Type)

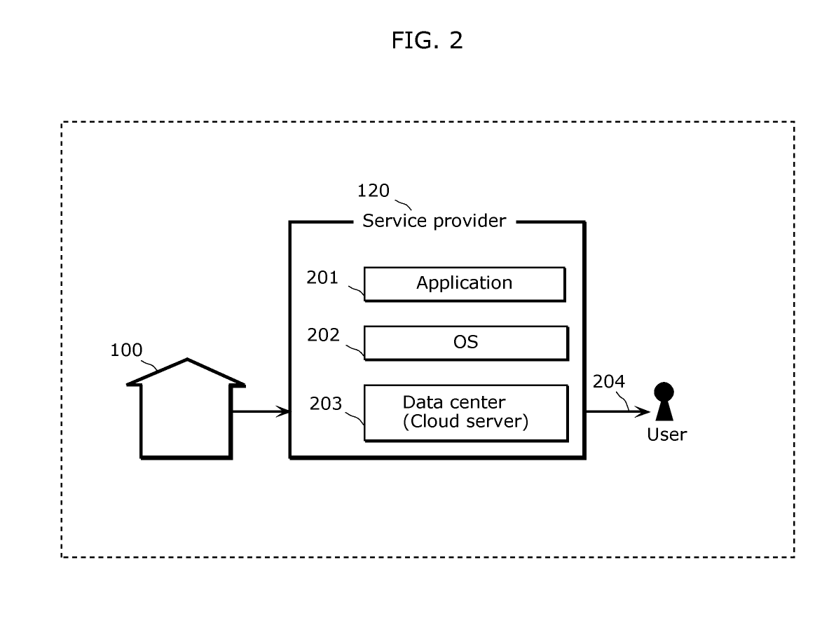

FIG. 2 illustrates a service type 1 (own data center type). In this type, a service provider 120 obtains information from a group 100 and provides a service to users. The service provider 120 in this type has a function that is the function of a data center operator. In other words, the service provider owns a cloud server 111 for managing big data. Thus, in this type, there is no actual data center operator.

In this type, the service provider 120 operates and manages a data center (cloud server 111) (203). Furthermore, the service provider 120 manages OS (202) and applications (201). The service provider 120 provides a service (204) using the OS (202) and applications (201) managed by the service provider 120 itself.

### (Service Type 2: IaaS-Based Type)

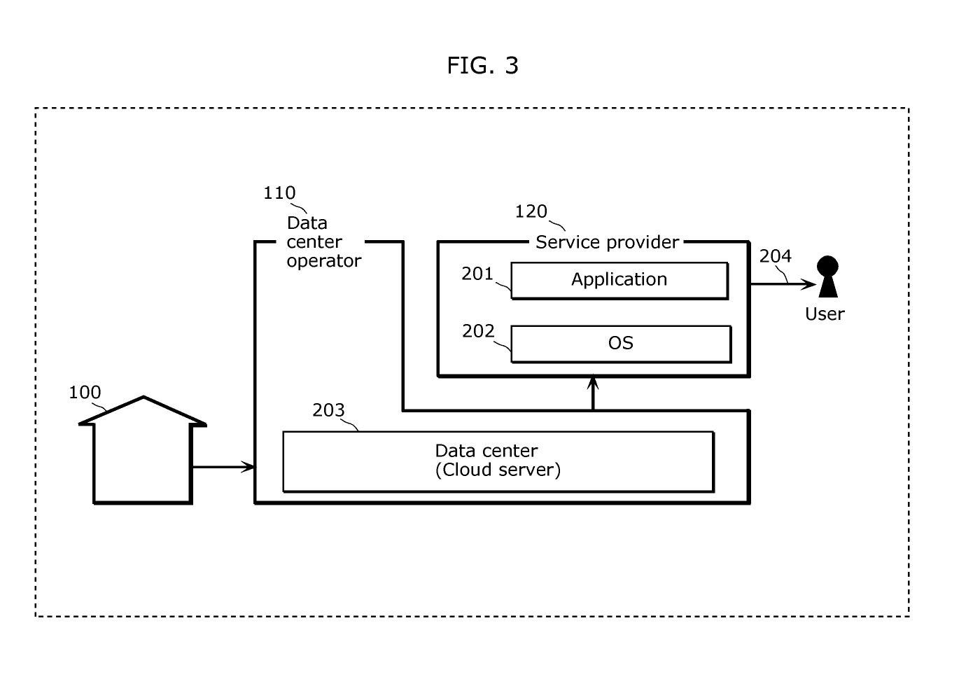

FIG. 3 illustrates a service type 2 (Infrastructure as a Service (IaaS)-based type). The term IaaS is an acronym for Infrastructure as a Service which refers to a model of a cloud service in which infrastructure for building and running a computer system is provided as a service via the Internet.

In this type, a data center operator operates and manages a data center (cloud server 111) (203). Furthermore, a service provider 120 manages OS (202) and applications (201). The service provider 120 provides a service (204) using the OS (202) and applications (201) managed by the service provider 120 itself.

### (Service Type 3: PaaS-Based Type)

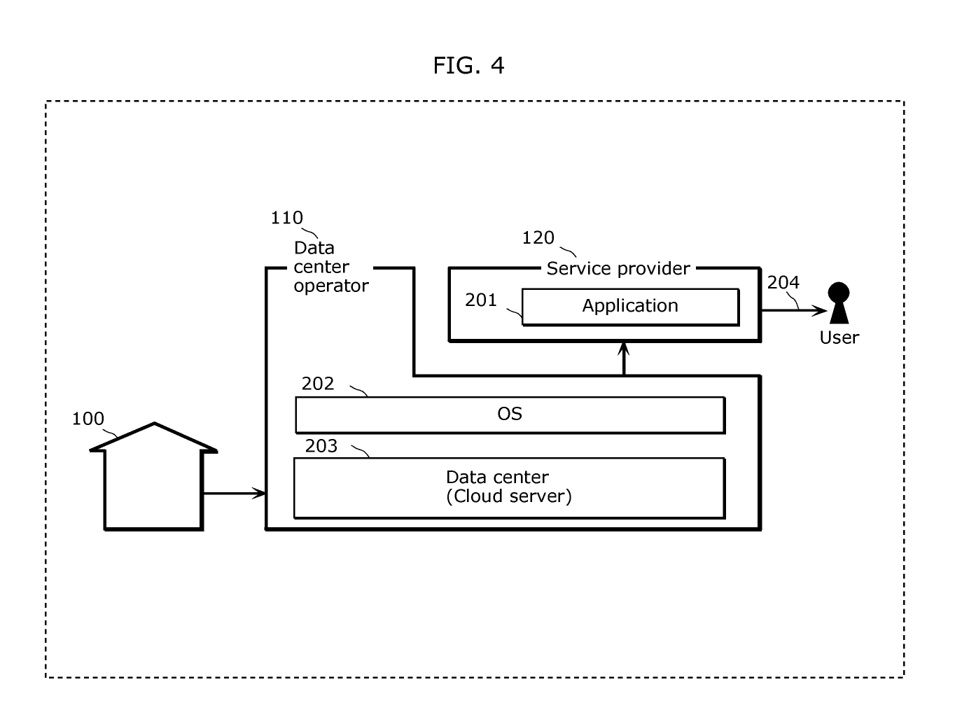

FIG. 4 illustrates a service type 3 (Platform as a Service (PaaS)-based type). The term PaaS is an acronym for Platform as a Service which refers to a type of a cloud service in which a platform for composing and running software is provided as a service via the Internet.

In this type, a data center operator 110 manages OS (202) and operates and manages a data center (cloud server 111) (203). Furthermore, the service provider 120 manages applications (201). The service provider 120 provides a service (204) using the OS (202) managed by the data center operator and the applications (201) managed by the service provider 120 itself.

### (Service Type 4: SaaS-Based Type)

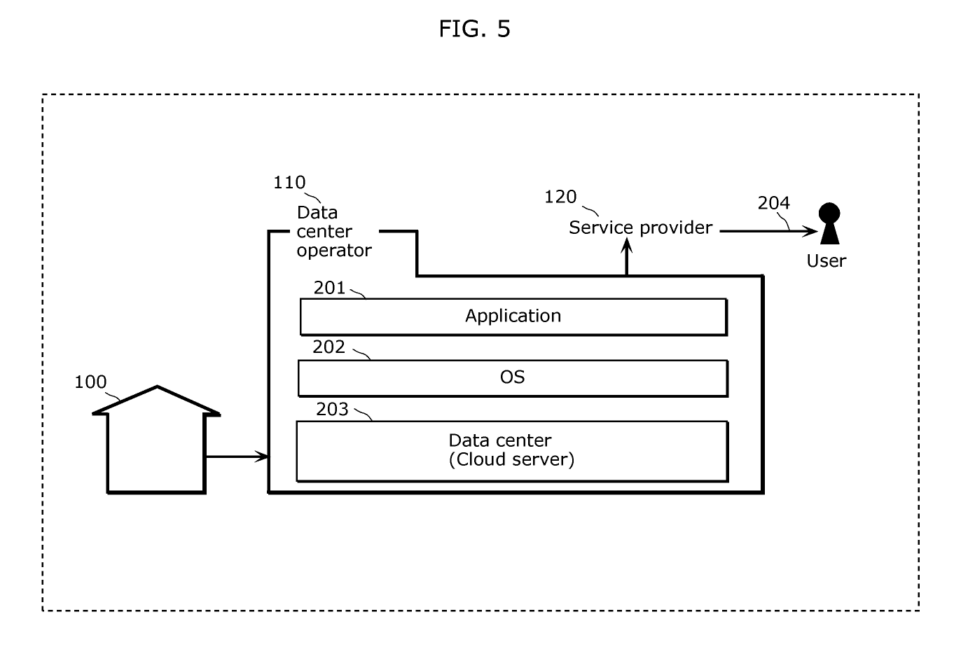

FIG. 5 illustrates a service type 4 (Software as a Service (SaaS)-based type). The term SaaS is an acronym for Software as a Service. For example, SaaS refers to a type of cloud service in which a company or a person (user) not having a data center (cloud server) is provided access to an application via a network such as the Internet by a platform provider having a data center (cloud server).

In this type, a data center operator 110 manages applications (201) and OS (202) and operates and manages a data center (cloud server 111) (203). The service provider 120 provides a service (204) using the OS (202) and applications (201) managed by the data center operator 110.

In any of the above types, the service provider 120 is considered as a provider of the service. For example, the service provider or the data center operator may develop OS, applications, or big data database and others by itself or may outsource the development to a third party.

It is to be noted that in each of the above non-limiting embodiments, each constituent element may be implemented by being configured with a dedicated hardware or being executed by a software program appropriate for each constituent element. Each constituent element may be implemented by reading and executing the software program recorded on a hard disk or a recording medium such as a semiconductor memory, performed by a program execution unit such as a CPU or a processor. Here, the software which implements the tweet generation-and-presentation server or the like in each of the above embodiments is a program described below.

Specifically, this program is a program for causing a computer to execute the content presentation method comprising: obtaining behavior history information of a user; determining a frequency for generating content based on the behavior history information and generating the content at the determined frequency, the content being for interaction with the user made by a device; and presenting the generated content to the user by distributing the generated content.

The foregoing has described the content management method according to one or more embodiments, however, the present invention is not limited to these embodiments. Other forms in which various modifications apparent to those skilled in the art are applied to the embodiments, or forms structured by combining constituent elements of different embodiments are included within the scope of the embodiments, unless such changes and modifications depart from the scope of the present invention.

### INDUSTRIAL APPLICABILITY

The automatic tweet generation system according to an aspect of the present invention allows the user to view information on home appliances easily and with fun, using information such as operation history or work history of home appliances and AV home appliances, for example. Thus, the automatic tweet generation system according to the present invention has a high possibility for use in the industries of home appliances and AV home appliances.

### REFERENCE SIGNS LIST

10, 20 User
100 Group
101 Device
102 Home gateway
110 Data center operator
111 Cloud server
120 Service provider
121 Server
201 Application
202 OS
203 Data center (cloud server)
204 User
601, 601A Tweet generation-and-view server
602 Device
603 Tweet view device
611 Tweet-generation-information setting unit
612 Device operation history DB
613 Device-operation-history collection unit
614 Tweet generation unit
616 Tweet frequency calculation unit
617 User-and-device management DB
618 View history DB
619 Tweet DB
620 Tweet presentation unit
621 Device management unit
622 Device management DB
631 Communication unit
632 Information input-and-output unit
1801 Device operation control unit

1. A content presentation method comprising:
obtaining behavior history information of a user;
determining a frequency for generating content based on the behavior history information and generating the content at the determined frequency, the content being for interaction with the user made by a device; and
presenting the generated content to the user by distributing the generated content.

2. The content presentation method according to claim 1,
wherein the determining further includes
determining a type of the content to be generated based on the behavior history information and generating the content of the determined type.

3. The content presentation method according to claim 1,
wherein, in the presenting, a view request for the content from the user is accepted and the content is presented to the user according to the view request accepted,
in the obtaining, information including a frequency of the view request accepted in the presenting is obtained as the behavior history information, and
in the determining, the content is generated at a lower frequency as the frequency of the view request in the behavior history information is lower, or the content is generated at a higher frequency as the frequency of the view request in the behavior history information is higher.

4. The content presentation method according to claim 3,
wherein in the obtaining, information for identifying a first time period is obtained as the behavior history information, the first time period being a time period in which the frequency of the view request accepted in the presenting is smaller than a first threshold, and
in the determining, the content in the first time period identified from the behavior history information is generated at a frequency lower than a frequency for generating the content in a time period other than the first time period.

5. The content presentation method according to claim 3,
wherein the type of the content includes a first type indicating content including an inquiry to the user and a second type different from the first type, and
in the determining, the content of the second type is generated at a lower frequency as the frequency of the view request in the behavior history information is lower, or the content of the second type is generated at a higher frequency as the frequency of the view request in the behavior history information is higher.

6. The content presentation method according to claim 1,
wherein in the obtaining, information including a frequency of an operation of the device by the user is obtained as the behavior history information, the information being defined based on a history of the operation by the user, and
in the determining, the content is generated at a lower frequency as the frequency of the operation in the behavior history information is lower, or the content is generated at a higher frequency as the frequency of the operation in the behavior history information is higher.

7. The content presentation method according to claim 6,
wherein in the obtaining, information for identifying a second time period, in which the frequency of the operation of the device by the user is lower than a second threshold, is obtained as the behavior history information, the information being defined based on the history of the operation by the user, and
in the determining, the content is generated in the second time period identified from the behavior history information at a frequency lower than a frequency for generating the content in a time period other than the second time period.

8. The content presentation method according to claim 6,
wherein the type of the content includes a first type indicating content including an inquiry to the user and a second type different from the first type, and
in the determining, the content of the first type is generated at a lower frequency as the frequency of the operation in the behavior history information is lower, or the content of the first type is generated at a higher frequency as the frequency of the operation in the behavior history information is higher.

9. The content presentation method according to claim 1,
wherein in the obtaining, information including position information of the user is obtained as the behavior history information, and
in the determining, when the position of the user identified from the behavior history information is not in a region that is set preliminarily, the content is generated at a lower frequency than when the position of the user is in the region.

10. A non-transitory computer-readable recording medium, the recording medium having a computer program recorded thereon for causing the computer to execute the content presentation method according to claim 1.
